(19) United States
(12) Patent Application Publication
(10) Pub. No.: US 2008/0243772 A1
(43) Pub. Date: Oct. 2, 2008

(54) METHOD AND SYTSEM FOR GENERATING NESTED MAPPING SPECIFICATIONS IN A SCHEMA MAPPING FORMALISM AND FOR GENERATING TRANSFORMATION QUERIES BASED THEREON

(76) Inventors: Ariel Fuxman, San Jose, CA (US); Mauricio Antonio Hernandez-Sherrington, Gilroy, CA (US); Ching-Tien Ho, San Jose, CA (US); Renee J. Miller, Toronto (CA); Paolo Papotti, Roma (IT); Lucian Popa, San Jose, CA (US)

Correspondence Address: SCHMEISER, OLSEN & WATTS, 22 CENTURY HILL DRIVE, SUITE 302, LATHAM, NY, 12110, US

(21) Appl. No.: 12/127,904

(22) Filed: May 28, 2008

Related U.S. Application Data
(63) Continuation of application No. 11/693,192, filed on Mar. 29, 2007.

(51) Int. Cl. G06F 17/30; G06F 17/00

(52) U.S. Cl. 707/2; 707/101; 707/E17.012; 707/E17.017

(57) ABSTRACT

A method and system for generating nested mapping specifications and transformation queries based thereon. Basic mappings are generated based on source and target schemas and correspondences between elements of the schemas. A directed acyclic graph (DAG) is constructed whose edges represent ways in which each basic mapping is nestable under any of the other basic mappings. Any transitively implied edges are removed from the DAG. Root mappings of the DAG are identified. Trees of mappings are automatically extracted from the DAG, where each tree of mappings is rooted at a root mapping and expresses a nested mapping specification. A transformation query is generated from the nested mapping specification by generating a first query for transforming source data into flat views of the target and a second query for nesting flat view data according to the target format. Generating the first query includes applying default Skolemization to the specification.

This application is a continuation application claiming priority to Ser. No. 11/693,192, filed Mar. 29, 2007.

### RELATED APPLICATIONS

This application is related to the following commonly assigned patent applications, which are hereby incorporated herein by reference in their entirety:

(1) U.S. patent application Ser. No. 11/326,969, filed on Jan. 6, 2006, and entitled “Mapping-Based Query Generation with Duplicate Elimination and Minimal Union.”

(2) U.S. patent application Ser. No. 11/343,503, filed on Jan. 31, 2006, and entitled “Schema Mapping Specification Framework.”

### FIELD OF THE INVENTION

The present invention discloses a method and system for generating nested mapping specifications in a schema mapping formalism and for generating transformation queries based on the nested mapping specifications.

### BACKGROUND OF THE INVENTION

Declarative schema mapping formalisms have been used to provide formal semantics for data exchange, data integration, peer data management, and model management operators such as composition and inversion. For relational schemas, widely used known formalisms for schema mappings are based on source-to-target tuple-generating dependencies (source-to-target tgds) or, equivalently, global-and-local-as-view (GLAV) assertions. Known direct extensions to schema mapping formalisms exist for schemas (e.g., eXtensible Markup Language (XML) schemas) containing nested data. These conventional formalisms provide inaccurate or underspecified mappings. Further, conventional mapping specifications generated under these known formalisms are fragmented into many small, overlapping formulas where the overlap may lead to redundant computation, hinder human understanding of the mappings, and/or limit the effectiveness of mapping tools. Thus, there exists a need to overcome at least one of the preceding deficiencies and limitations of the related art.

### SUMMARY OF THE INVENTION

In first embodiments, the present invention provides a computer-implemented method of generating nested mapping specifications, the method comprising:

receiving, by a computing system, one or more source schemas, a target schema, and one or more correspondences between one or more elements of each source schema of the one or more source schemas and one or more elements of the target schema;

generating, by the computing system, a set of basic mappings based on the one or more source schemas, the target schema, and the one or more correspondences;

constructing, by the computing system, a directed acyclic graph (DAG) whose edges represent all possible ways in which each basic mapping of the set of basic mappings is nestable under any other basic mapping of the set of basic mappings;

removing, by the computing system, any transitively implied edges from the DAG;

identifying, by the computing system and subsequent to the modifying, one or more root mappings of the DAG; and

extracting, automatically by the computing system, one or more trees of mappings from the DAG, each tree of mappings being rooted at a root mapping of the one or more root mappings and each tree of mappings expressing a nested mapping specification.

In second embodiments, the present invention provides a computer-implemented method of generating a transformation query from a nested mapping specification based on a source schema and a target schema, the method comprising:

generating, by a computing system, a first-phase query for transforming source data into a set of flat views of the target schema; and

generating, by the computing system, a second-phase query as a wrapping query for a nesting of data of the flat views according to a format of the target schema,

wherein the generating the first-phase query includes:
applying default Skolemization to a nested mapping specification, the applying including replacing an existentially-quantified variable in the nested mapping specification by a Skolem function that depends on all universally-quantified variables that are positioned in the nested mapping specification before the existentially-quantified variable;
decoupling, in response to the applying, the nested mapping specification into a set of single-headed constraints, each single-headed constraint including a single implication and an atom included in a consequent of the single implication; and
storing a plurality of facts asserted by the set of single-headed constraints into the set of flat views.

Systems and computer program products corresponding to the above-summarized methods are also described herein.

Advantageously, the present invention provides a nested mapping formalism and technique for generating nested mapping specifications and transformation queries based thereon that permit the expression of powerful grouping and data merging semantics declaratively within the mapping. Further, the nested mapping formalism described herein yields more accurate specifications, and when used in data exchange, improves the quality of exchanged data (e.g., reduces redundancy in the target data) and drastically reduces the execution cost of producing a target instance. The nested mappings described herein naturally preserve correlations among data that existing mapping formalisms cannot. Still further, the nested mapping formalism provides an ability to express, in a declarative way, grouping and data merging semantics that are easily changed and customized to any particular integration task. Further yet, the transformation query generation technique described herein scale well to large, highly nested schemas.

### BRIEF DESCRIPTION OF THE DRAWINGS

FIG. 1 is an example of source and target schemas and four basic mappings, in accordance with embodiments of the present invention.

FIG. 2 is an example of a nested mapping corresponding to FIG. 1, in accordance with embodiments of the present invention.

FIG. 3 is an example of a mapping scenario with two basic mappings, in accordance with embodiments of the present invention.

FIG. 4 is an example of a source instance and an undesirable target instance that satisfy constraints corresponding to the mappings of FIG. 3, in accordance with embodiments of the present invention.

FIG. 5 depicts a desirable target instance required by a nested mapping, in accordance with embodiments of the present invention.

FIG. 6 depicts exemplary source and target data for the scenario of FIG. 3, in accordance with embodiments of the present invention.

FIG. 7A is a block diagram of a system for generating nested mapping specifications and for generating transformation queries using nested mapping specification input, in accordance with embodiments of the present invention.

FIG. 7B is a flow diagram of a process for generating a nested mapping specification in the system of FIG. 7A, in accordance with embodiments of the present invention.

FIG. 7C is a flow diagram of details of part of the process of FIG. 7B, in accordance with embodiments of the present invention.

FIG. 8A is an example of source and target tableaux used in a basic mapping generation algorithm, in accordance with embodiments of the present invention.

FIG. 8B is an example of tableaux hierarchies corresponding to the tableaux of FIG. 8A, in accordance with embodiments of the present invention.

FIG. 9A is an example of basic mappings that are the reverse of the mapping scenario of FIG. 3, in accordance with embodiments of the present invention.

FIG. 9B depicts nestable and non-nestable relationships between the mappings of FIG. 9A, in accordance with embodiments of the present invention.

FIG. 10 is a flow diagram of a process of generating a nested mapping query in the system of FIG. 7A, in accordance with embodiments of the present invention.

FIG. 11 is a flow diagram of a two-phase query generation process included in the process of FIG. 10, in accordance with embodiments of the present invention.

FIG. 12 is a flow diagram of a query optimization process included in the process of FIG. 10, in accordance with embodiments of the present invention.

FIG. 13A depicts a basic mapping query used to compare the performance of basic mapping queries with the performance of nested mapping queries, in accordance with embodiments of the present invention.

FIG. 13B depicts a nested mapping query whose performance is compared to the performance of the basic mapping query of FIG. 13A, in accordance with embodiments of the present invention.

FIG. 14A is a graph illustrating that, relative to query execution time, nested mapping queries generated by the process of FIG. 10 outperform basic mapping queries, in accordance with embodiments of the present invention.

FIG. 14B is a graph illustrating that, relative to the size of the output instance generated, nested mapping queries generated by the process of FIG. 10 outperform basic mapping queries, in accordance with embodiments of the present invention.

FIGS. 15A-15B depict two synthetic scenarios used to evaluate the performance and scalability of the nested mapping specification generation process of FIG. 7B, in accordance with embodiments of the present invention.

FIG. 16 is a graph illustrating mapping generation execution time results for the synthetic scenario of FIG. 15B, in accordance with embodiments of the present invention.

FIG. 17 is a block diagram of a computing system that includes components of the system of FIG. 7A and that implements the processes of FIG. 7B and FIG. 10, in accordance with embodiments of the present invention.

### DETAILED DESCRIPTION OF THE INVENTION

### 1. Introduction

Many problems in information integration rely on specifications that model relationships between schemas. These specifications, called schema mappings, play a central role in both data integration and in data exchange. Considered herein are schema mappings over pairs of schemas that express a relation on the sets of instances of two schemas. Presented herein is a new formalism for schema mapping that extends existing formalisms in two significant ways. First, nested mappings allow for nesting and correlation of mappings. Second, the extension to the mapping formalism includes an ability to express, in a declarative way, grouping and data merging semantics. Further, the present invention includes a new algorithm for an automatic generation of nested mapping specifications from schema matchings (i.e., simple element-to-element correspondences between schemas). Still further, the present invention includes the implementation of this algorithm, along with algorithms for the generation of transformation queries (e.g., XQuery) based on nested mapping specifications.

### 1.1 Current Schema Mapping Formalisms

Source-to-target tgds and GLAV assertions are constraints between relational schemas. They are expressive enough to represent, in a declarative way, many of the relational schema mappings of interest. This section examines an extension of source-to-target tgds designed for schemas with nested data that is based on path-conjunctive constraints, and that have been used in systems for data exchange, data integration, and schema evolution. Such mappings are referred to herein as basic mappings. These mappings form the basic building blocks for the nested mappings discussed below. In related literature, these basic mappings have sometimes been referred to as nested constraints or dependencies, since they are constraints on nested data. The mappings themselves, however, have no structure or nesting. Hence, the present application uses the term “basic” to distinguish these mappings from the more structured nested mappings that are discussed below. The basic mappings referred to herein are the logical mappings described in U.S. Patent Application Publication No. 2004/0199905 A1 (Fagin et al., “System and method for translating data from a source schema to a target schema”), which is hereby incorporated herein by reference in its entirety. The basic mappings referred to herein are also the mappings described in U.S. patent application Ser. No. 11/343,503.

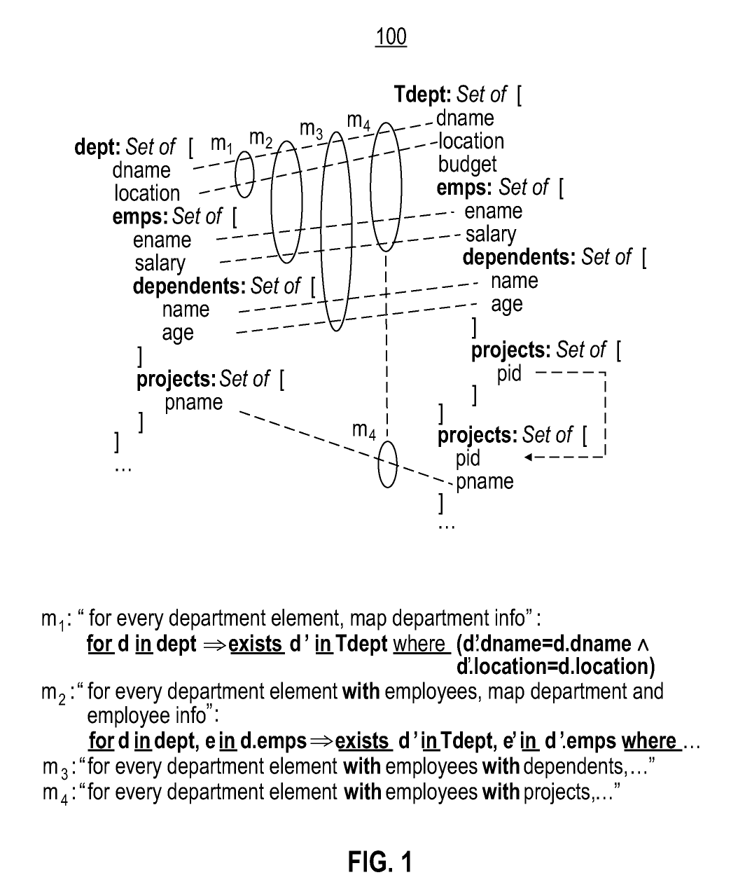

To illustrate the use of basic mappings, consider mapping example 100 shown in FIG. 1. The source schema, illustrated on the left of example 100, is a nested schema describing departments with their employees and projects. The source schema includes a top-level set of department records, and each department record has a nested set of employee records. There is additional nesting in that each employee has a set of dependents and a set of projects. Each set can be empty, in general. The target schema, shown on the right of example 100, is a slight variation of the source schema.

The formulas that are presented below the schemas in example 100 are examples of basic mappings. The formulas are constraints that describe, in a declarative way, the mapping requirements. These formulas may be generated by a tool from the correspondences between schema elements, or may be written by a human expert and interpreted by a model management tool or other integration tools. Section 2 provides a precise semantics for the schema and basic mapping notation.

Each formula (i.e., each mᵢ) in example 100 addresses one possible “case” in the source data, where each case is expressed by a conjunction of navigation paths joined in certain ways. In order to cover all possible cases of interest, many such formulas are needed. However, many of the cases overlap (i.e., have common navigation paths). Hence, common mapping behavior must be repeated in many formulas. For example, the formula m₂ must repeat the mapping behavior that m₁ already specifies for department data, although m₂ includes the mapping behavior for department data in a more specialized context. Otherwise, if only the mapping behavior for employees is specified in m₂, the association that exists in the source between employees and their departments is lost in the target since there is no correlation between m₁ and m₂. At the same time, m₁ cannot be eliminated from the specification, since m₁ deals with departments in general (i.e., departments that are not required to have employees). Also, in example 100, m₃ and m₄ include a common mapping behavior for employees and departments, but m₃ and m₄ differ in that they map different components of employees: dependents and projects.

Such formulas are relatively easy to generate and reason about. This is partly why they have been widely used in research. However, the number of formulas quickly increases with large schemas, leading to an explosion in the size of the specification. This explosion as well as the overlap in behavior causes significant usability problems for human experts and for tools using these specifications in practice.

Inefficiency in execution: In a naive use of basic mappings, each mapping formula may be interpreted separately. Optimization of these mappings requires sophisticated techniques that deduce the correlations and common subexpressions within the mappings.

Redundancy in the specification: When using basic mappings in data exchange, the same piece of data may be generated multiple times in the target due to the multiple formulas. In addition to possible run-time inefficiency, this multiple generation of the same piece of data puts additional burden on methods for duplicate elimination or data merging. In example 100, an employee may be generated three times in the target: once for m₂ with an empty set of dependents and an empty set of projects, once for m₃ with a non-empty set of dependents and once for m₄ with a nonempty set of projects. Merging of the three employee records into one is more than just duplicate elimination: it requires merging of two nested sets as well. Furthermore, this raises the question of when to merge in general since this is not expressed in any way by the mapping formulas of FIG. 1.

Underspecified grouping semantics: The formula m₂ requires that for every department and for every employee record in the source there must exist, in the target, a “copy” of the department record with a “copy” of the employee record nested underneath. However, it is left unspecified whether to group multiple employees who are common for a given department name (dname), or whether to group by other fields, or whether not to group at all. Again, one of the reasons for this lack of expressive power is the simplicity of these basic mapping formulas. A known default grouping behavior is based on partitioned normal form (PNF) which always groups nested sets of elements by all the atomic elements at the upper levels. Under PNF semantics in example 100, employees are grouped by dname and location, assuming that budget is not mapped and its value is null. In effect, the semantics of the transformation is specified in two parts: first the mapping formulas, and then the implicit PNF-based grouping semantics. An important limitation of this approach is that the default grouping semantics is not specified declaratively, and it cannot be easily changed or customized when it is not the desired semantics.

### 1.2 Nested Mappings

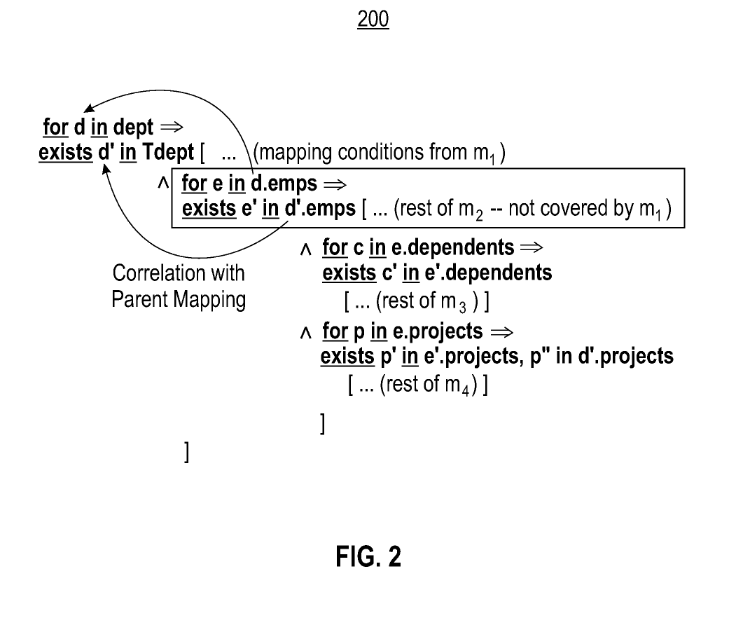

In order to address the issues described in Section 1.1, the present invention includes an extension to basic mappings that is based on arbitrary nesting of mapping formulas within other mapping formulas. This formalism is referred to herein as the language of nested mappings. Nested mappings offer a more natural programming paradigm for mapping tasks, since human users tend to design a mapping from top to bottom, component-wise: define first how the top components of a schema relate, then define, recursively, via nested submappings, how the subcomponents relate, and so on. The nested mapping corresponding to example 100 is illustrated by nested mapping 200 in FIG. 2. Nested mapping 200 relates, at the top-level, source departments with target departments. Nested mapping 200 then continues, in this context of a department-to-department mapping, with a submapping relating the corresponding employees, which then continues with submappings for dependents and projects. At each level, there are correlations between the current submapping and the upper-level mappings. In particular, nothing is repeated from the upper level, but instead reused.

Advantages of nested mappings: To a large extent, nested mappings overcome the aforementioned shortcomings of basic mappings. First, fewer formulas are needed and overall a more natural and accurate specification is produced. For the corresponding examples shown in FIGS. 1 and 2, one nested mapping in FIG. 2 replaces four basic mappings in FIG. 1. In general, multiple nested mappings may still be needed (e.g., when there are multiple data sources). Second, by using nested mappings, more efficient data exchange queries can be produced. Because nested mappings factor out common subexpressions, the number of passes over the same input data can be more easily optimized. For the aforementioned example in FIG. 2, department records can be scanned only once, and the entire work involving the subelements can be done in the same pass by the submappings. The execution also generates much less redundancy in the target data. An employee is generated once, and all dependents and projects are added together by the two corresponding submappings.

Nested mappings also have a natural, built-in, grouping behavior that follows the grouping of data in the source. For example, the nested mapping in FIG. 2 requires that all the employees in the target are grouped in the same way as they are in the source. This grouping behavior is ideal for mappings between two similar schemas (e.g., in schema evolution) where much of the data should be mapped using the identity or mostly-identity mapping. For more complex restructuring tasks, additional grouping behavior may need to be specified. The present invention uses a simple, but powerful, mechanism for adding such grouping behavior by using explicit grouping functions (i.e., a restricted form of Skolem functions).

Summary of Contributions: The present invention includes a nested mapping formalism for representing the relationship between schemas for relational or nested data (see Section 2). Further, an algorithm for generating nested mappings from matchings (i.e., correspondences) between schema elements is described herein. The nested nature of the mappings makes this generation task more challenging than in the case of basic mappings (see Section 3). Still further, the present invention includes an algorithm for the generation of data transformation queries that implement data exchange based on nested mapping specifications. Notably this algorithm for generating transformation queries can handle all nested mappings, including those generated by the mapping algorithm described herein as well as arbitrary customizations of these mappings. Such customizations of mappings are made, for example, by a user to capture specialized grouping semantics (see Section 4). Further yet, the description that follows illustrates experimentally that the use of nested mappings in data exchange drastically reduces the execution cost of producing a target instance, and also dramatically improves the quality of the generated data. Examples of important grouping semantics that cannot be captured by basic mappings and an empirical showing that underspecified basic mappings may lead to significant redundancy in data exchange are shown below (see Section 5).

### 2. Mappings within Mappings

This section describes the notation and terminology for schemas and mappings. Further, qualitative differences between basic mappings and nested mappings are described in detail.

### 2.1 Basic Mappings

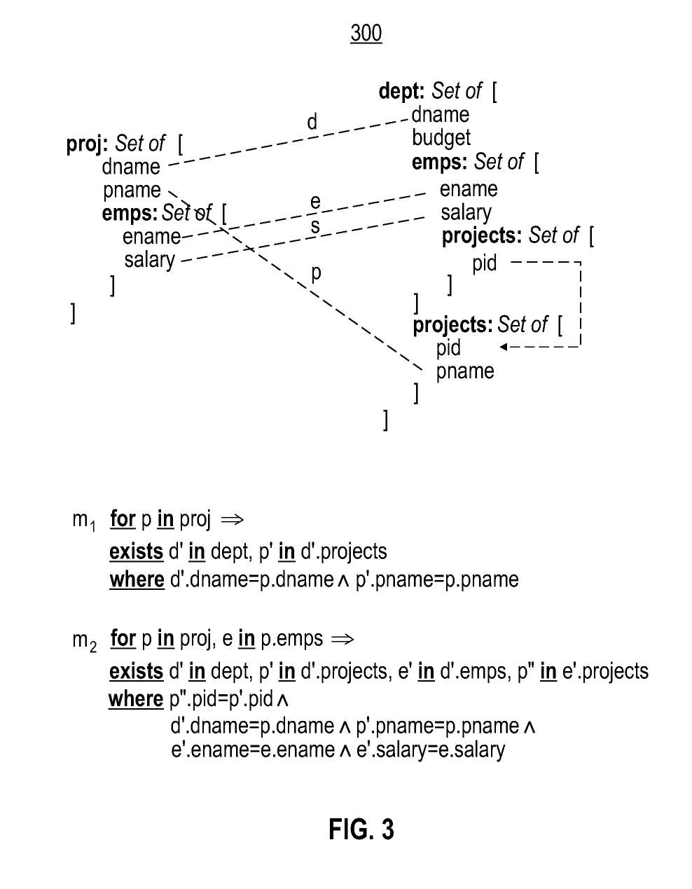

Consider the mapping scenario 300 illustrated in FIG. 3. The two schemas in FIG. 3 (i.e., source schema on the left and target schema on the right) are shown in a nested relational representation that can be used as a common abstraction for relational and XML schemas and other hierarchical set-oriented data formats. This representation is based on sets and records that can be arbitrarily nested. In the source schema of scenario 300, proj is a set of records with two atomic components, dname (i.e., department name) and pname (i.e., project name), and a set-valued component, emps, that represents a nested set of employee records. The target schema of scenario 300 is a reorganization of the source: at the top-level is a set of department records, with two nested sets of employee and project records. Moreover, each employee in the target schema of FIG. 3 can have its own set of project ids (i.e., pids), which must appear at the department level, as is required by the foreign key indicated by the arrow in FIG. 3.

Formally, a schema is a set of labels (a.k.a. the roots of the schema or schema roots), each with an associated type τ, defined by τ::=Str|Int|SetOfτ|[l₁:τ₁, . . . , lₙ:τₙ], where l₁, . . . , lₙ are labels. FIG. 3 does not show any of the atomic types. It should be noted that the aforementioned definition for type r is only a simplified abstraction. The system that implements the present invention also deals with choice types, optional elements, nullable elements, etc. However, the presence of these additional features does not essentially change the formalism.

FIG. 3 also shows two basic mappings that can be used to describe the relationship between the source and the target schemas. The first basic mapping in FIG. 3, m₁, is a constraint that maps department and project names in the source schema to corresponding elements in the target, where the mapping is independent of whether any employees exist in emps. The second basic mapping in FIG. 3, m₂, is a constraint that maps department and project names and their employees, whenever such employees exist.

FIG. 3 uses a “query-like” notation, with variables bound to set-type elements. Each variable can be a record and hence include multiple components. Correspondences between schema elements (e.g., dname to dname) are captured by equalities between such components (e.g., d′.dname=p.dname). These equalities are grouped in the where clause that follows the exists clause of a mapping. Moreover, equalities are also used to express join conditions or other predicates in the source or in the target. For example, see the requirement on pid in m₂ that appears in the same where clause.

Logic-based notation: Alternatively, a “logic-based” notation is used for mappings that quantify each individual component in a record as a variable. In particular, nested sets are explicitly identified by variables. Each mapping is an implication between a set of atomic formulas over the source schema and a set of atomic formulas over the target schema. Each atomic formula is of the form e(x₁, . . . , xₙ) where e denotes a set, and x₁, . . . , xₙ are variables. For simplicity of presentation, a strict alternation of set and record types in a schema is assumed herein. The main difference from the traditional relational atomic formulas is that e may be a top-level set (e.g., proj), or it may be a variable in order to denote sets that are nested inside other sets. As presented in formulas herein, the atomic variables are written in lower-case and the set variables in upper-case. The formulas corresponding to the mappings m₁ and m₂ of FIG. 3 are:

m1:proj(d,p,Eₛ)→dept(d,?b,?E,?P) [symbol] P(?x,p) (1)

m2:proj(d,p,Eₛ) [symbol] Eₛ(e,s)→dept(d,?b,?E,?P)̂E(e,s,?P′) [symbol] P′(?x)̂P(x,p) (2)

For each of the formulas (1) and (2) presented above, the variables on the left of the implication are assumed to be universally quantified. In formulas (1) and (2), the variables on the right of the implication that do not appear on the left of the implication are assumed to be existentially quantified. For clarity, the quantifiers are omitted and a question mark is used in front of the first occurrence of an existentially-quantified variable.

For example, in m₂ (i.e., formula (2) presented above), the variable Eₛ denotes the nested set of employee records inside a tuple in the top-level set proj. The variables E, P, and P′ are also set variables, but existentially quantified. The variables b (i.e., denoting budget) and x (i.e., denoting project id) are existentially quantified as well, but are atomic. The meaning of m₂ is: for every source tuple (d, p, Eₛ) in proj, and for every tuple (e, s) in the set Eₛ, there must exist four tuples in the target as follows. First, there must be a tuple (d, b, E, P) in dept, where b is some “unknown” budget, E identifies a set of employee records, and P identifies a set of project records. Then, there must exist a tuple (e, s, P′) in E, where P′ identifies a set of project ids. Furthermore, there must exist a tuple (x) in P′, where x is an “unlnown” project id. Finally, there must exist a tuple (x, p) in the previously mentioned set P, where x is the same project id used in P′. Notice that all data required to be in the target by the mapping satisfies the foreign key for the projects.

### 2.2 Correlating Mappings via Nesting

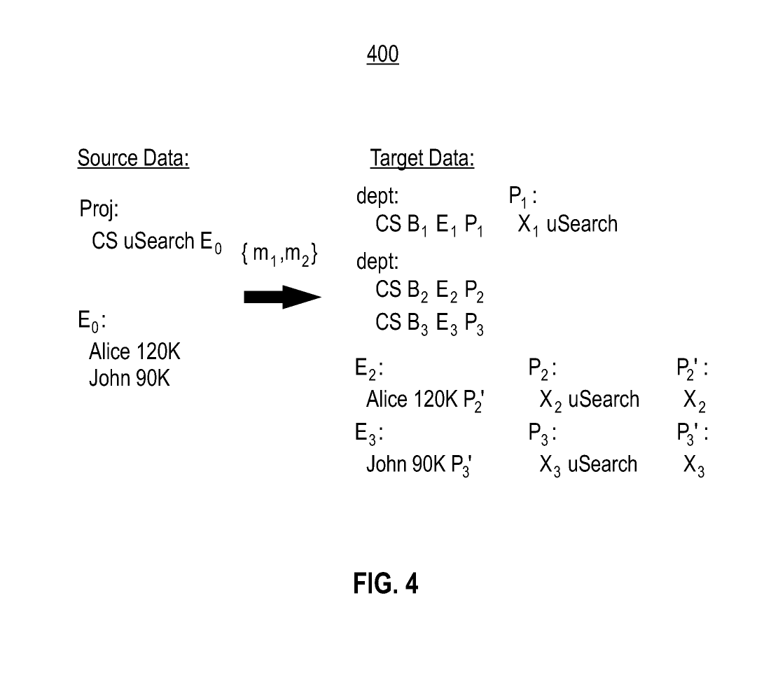

In this section, actual data is presented in order to provide an understanding of the semantics of basic mappings, and to see why such specification language is not entirely satisfactory. In example 400 in FIG. 4, source and target instances are shown that satisfy the constraints m₁ and m₂. In the source, E₀ is a “name”, or set id, for the nested set of employee records corresponding to the tuple given in proj. It is assumed that every nested set has such an id. Similarly, E₁, P₁, E₂, . . . , P₃′ are set ids in the target instance. The top two target tuples, for dept and P₁, respectively, ensure that m₁ is satisfied; the rest are used to satisfy m₂.

In general, for a given source instance, there may be several target instances satisfying the constraints imposed by the mapping specification. Given the specification {m₁, m₂}, the target instance shown in FIG. 4 is considered to be the most general that can be produced (i.e., a universal solution), because the target instance is the one that makes the least assumptions. For example, the target instance of FIG. 4 does not assume that E₁ and E₂ are equal since this assumption is not required by the specification. However, this target instance may not be satisfactory for a number of reasons. First, there is redundancy in the output: there are three dept tuples generated for “CS”, for different instantiations of the left-hand sides of m₁ and m₂. Also, there are three project tuples for “uSearch” although in different sets. Second, there is no grouping of data in the target: E₂ and E₃ are different singleton sets, generated for different instantiations of the left-hand side of m₂. This lack of grouping of data in the target does not violate the constraints, however, since the mapping specification does not require E₂ and E₃ to be equal. The same lack of grouping of data in the target applies to P₂ and P₃.

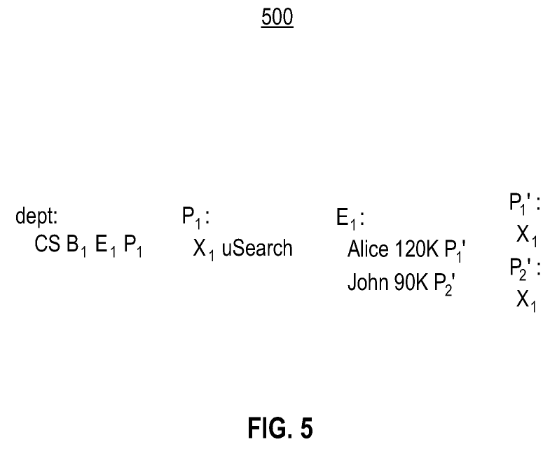

A target instance 500 that is more “desirable” is shown in FIG. 5. Target instance 500 has no redundant departments or projects, and it maintains the grouping of employees that exists in the source. While this instance satisfies the constraints m₁ and m₂, for the given source instance, it is not required by these mappings. In particular, the specification given by {m₁, m₂} does not rule out the undesired target instance of FIG. 4.

The present invention provides a specification that “enforces” correlations such as the ones that appear in the more “desirable” target instance (e.g., that the two source employees appear in the same set in the target). In particular, it would be advantageous to correlate the mapping m₂ with m₁ so that it reuses the set id E for employees that is already asserted by m₁ along with other existentially-quantified elements in m₁, without repeating the common part, which is m₁ itself. This correlating of the mapping m₂ with m₁ is done using the following nested mapping:

n: proj(d,p,Eₛ)→[dept(d,?b,?E,?P) [symbol] P(?x,p) [symbol] [Eₛ(e,s)→E(e,s,?P′) [symbol] P′(x)]] (3)

The inner implication in n (i.e., the third line of the nested mapping (3) shown above) is a submapping. The rest of n is referred to as the outer mapping. The submapping is correlated to the outer mapping because it reuses the existential variables E and x. In particular, the submapping requires that for every employee tuple in the set Eₛ, where Eₛ is bound by the outer mapping, there must exist an employee tuple in the set E, which is also bound by the outer mapping. Also, there must exist a project tuple in the set P′ associated to this employee, and the project id must be precisely the one (i.e., x) already required by the outer mapping. Note that P′ is now existentially quantified and bound in the inner mapping.

A fundamental observation about the nested mapping n shown above is that the “undesirable” target instance of FIG. 4 does not satisfy its requirements. For example, when the outer mapping of n is applied to proj(CS, uSearch, E₀), dept(CS, B₁, E₁, P₁) is required to be in the target. When the submapping is applied to E₀(Alice, 120K) and E₀(John, 90 K), tuples for Alice and John must be within the same set E₁. The nested mapping explicitly rules out the target instance of FIG. 4, and is a tighter specification for the desired schema mapping.

Another important observation is that there is no set of basic mappings that is equivalent to the nested mapping (3) shown above. Thus, the language of nested mappings is strictly more expressive than that of basic mappings.

Finally, a query-like notation (4) for the nested mapping (3) is presented below. Notice that the variables p, d′ and p′ from the outer level are being reused in the inner level.

n: for p in proj [symbol] exists d′ in dept, p′ in d′.projects where d′.dname=p.dname [symbol] p′.pname=p.pnamê(for e in p.emps [symbol] exists e′ in d′.emps,p″in e′.projects where p″.pid=p′.pid [symbol] e′.ename=e.ename [symbol] e′.salary=e.salary) (4)

### 2.3 Grouping and Skolem Functions

As seen in the example presented in Section 2.2, nested mappings can take advantage of the grouping that exists in the source, and require the target data to have a similar grouping. In the example of Section 2.2, all the employees that are nested inside one source tuple are required to be nested inside the corresponding target tuple. This section shows how a restricted form of Skolem functions can be used to model groupings of data that may not be present in the source.

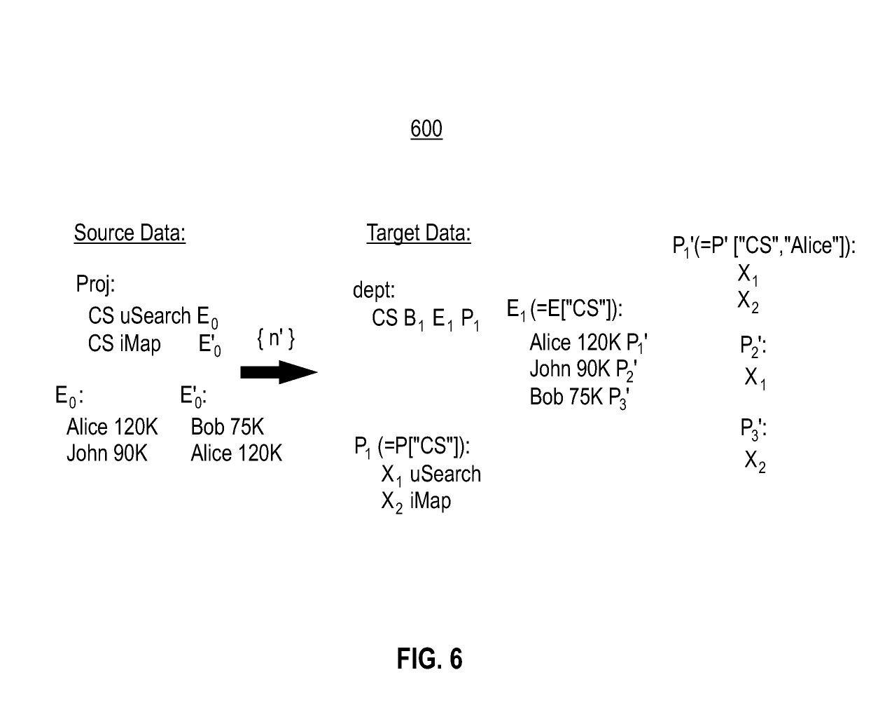

To illustrate, consider again the source schema in FIG. 3. Example 600 in FIG. 6 shows source and target data for this schema. The left side of example 600 shows a source instance that extends the source instance of FIG. 4. In particular, the “CS” department is associated with two different projects instead of one. The right side of example 600 shows a desired target instance, where projects are grouped by department name. This target instance is not required by the nested mapping n, which allows target instances which may have multiple department tuples with the same dname value, each with a singleton set containing one project. In other words, the source data is flat and, consequently, the target data is flat as far as the relationship between departments and projects goes. Furthermore, the nested mapping presented above does not merge sets of employees that appear in different source tuples with the same department name, in contrast with the target instance shown in FIG. 6.

Suppose now that all projects of a department are to be grouped into one set. Similarly, all the projects for each employee in a department are to be grouped into one set. Also, all the employees for a given department are to be merged. To generate such new groupings of data, an addition to the specification is required, since nesting of mappings alone is not flexible enough to describe such groupings. The mechanism added to the specification is that of Skolem functions for set elements. Intuitively, such functions express that certain sets in the target must be functions of certain values from the source. For the example presented above, to express the desired grouping, the nested mapping is enriched with three Skolem functions for the three nested set types in the target, as follows:

n′: f or p in proj [symbol] exists d′ in dept, p′ in d′.projects where d′.dname=p.dname [symbol] p′.pname=p.pname [symbol] d′.emps=E[p.dname] [symbol] d′.projects=P[p.dname] [symbol] (for e in p.emps [symbol] exists e′ in d′.emps,p″ in e′.projects where p″.pid=p′.pid [symbol] e′.ename=e.ename [symbol] e′.salary=e.salary [symbol] e′.projects=P′[p.dname,e.ename])

The new mapping constrains the target set of projects to be a function of only department name: P[p.dname]. Also, there must be only one set of employees per department name, E[p.dname], meaning that multiple sets of employees for different source tuples with the same department name must be merged into one set. Similarly, all projects of an employee in a department must be merged into one set.

More concretely, for the source tuple proj(CS, uSearch, E₀) of FIG. 6, the outer mapping of n′ requires that the target contains dept(CS, B₁, E₁, P). In addition, E[“CS”] (i.e., the result of applying the Skolem function E to the value “CS”) corresponds to E₁. Due to the inner mapping, the two employees of E₀ (i.e., “Alice” and “John”) must be in E₁. Now consider the source tuple (CS, iMap, E′₀). The mapping n′ requires the employees working on the “iMap” project (i.e., Bob and Alice) to also be within the set E₁. The reason for this requirement is that, according to n′, the employees of “iMap” must also be in E[“CS”], which is E₁.

The following natural restriction should be noted: The for clause of a submapping can use a correlation variable (i.e., bound in an upper-level mapping) only if that variable is bound in a for clause of the upper-level mapping. A similar restriction holds for the usage of correlation variables in exists clauses.

Using the logic-based notation, every nested mapping having no explicit Skolem functions is equivalent to one in which default Skolem functions are assigned to all the existentially-quantified set variables. The default arguments to such Skolem functions are all the universally quantified variables that appear before the set variable.

As an example, the aforementioned nested mapping n is equivalent to one in which the target set of projects nested under each dept tuple is determined by a Skolem function of all three components of the input proj tuple (i.e., dname, pname, and emps). In other words, there must be a set of target projects for each input proj tuple. Of course, this set of target projects needed for each input proj tuple does not require any grouping of projects by departments. However, once exposed to a user, the Skolem functions can be customized in order to achieve different grouping behavior, such as the one seen with the earlier mapping n′. The approach followed by the present invention is: first generate nested mappings with no Skolem functions, and then apply default Skolemization, which can then be altered in a GUI by a user.

Skolem functions and data merging: The example presented in Section 2.3 illustrates how one occurrence of a Skolem function permits data to be accumulated into the same set. Furthermore, the same Skolem function may be used in multiple places of a mapping or even across multiple mappings. Thus, different mappings correlated via Skolem functions may contribute to the same target sets, effectively achieving data merging. This is a typical requirement in data integration. Hence, Skolem functions are a declarative representation of a powerful array of data merging semantics.

As an interesting example of a set being shared from multiple places, consider the case when “Alice” has different salaries (i.e., 120K and 130K) in the two tuples in the source of FIG. 6. Then the aforementioned mapping n′ requires that there be two different “Alice” tuples in the target. Both of these required tuples are in the set E₁=E[“CS”]. Moreover, the same set of projects is constructed for the two Alice tuples since the projects set id is a Skolem function (i.e., P′) of “CS” and “Alice” and does not take into account salary. This example showcases an interesting feature of the mapping language, which is the ability to merge several components of a piece of data while still keeping other components separated (e.g., separated until further resolution).

### 3. Generation of Nested Mappings

This section describes an algorithm for the generation of nested mappings. Given two schemas, a source and a target, and a set of correspondences between atomic elements in the schemas, the algorithm generates a set of nested mappings that best reflects the given schemas and correspondences. Section 3.1 includes the first two steps in an algorithm for generating basic mappings. Section 3.2 describes an additional step in which unlikely basic mappings are pruned. This pruning significantly reduces the number of basic mappings. Section 3.3 defines when a basic mapping can be nested under another basic mapping. The pruned basic mappings are then input to the final step in the algorithm to generate nested mappings (see Section 3.4).

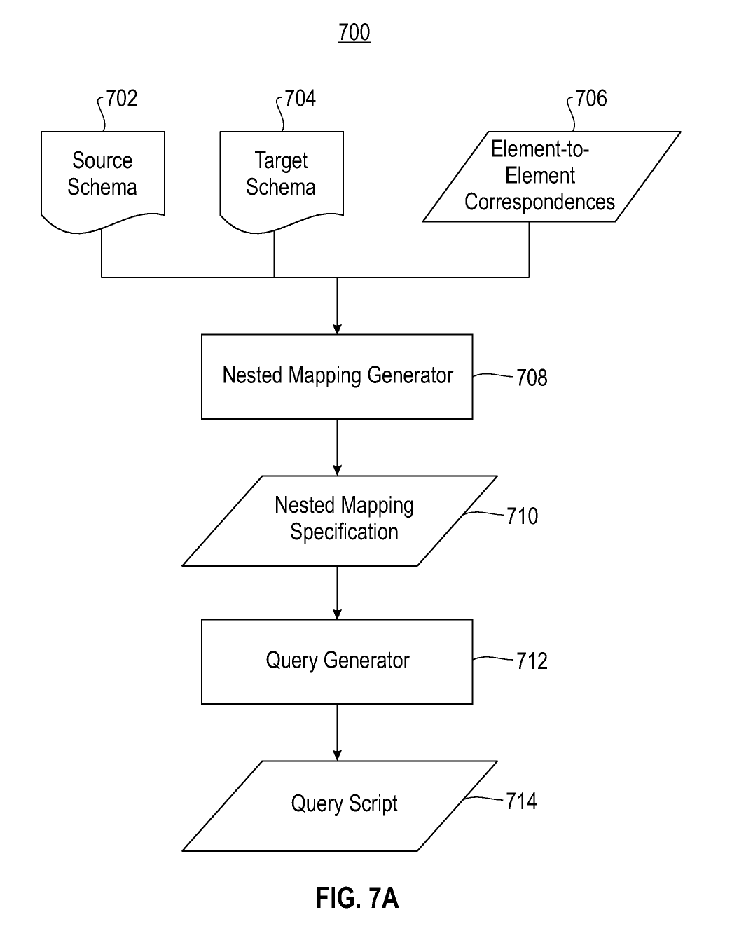

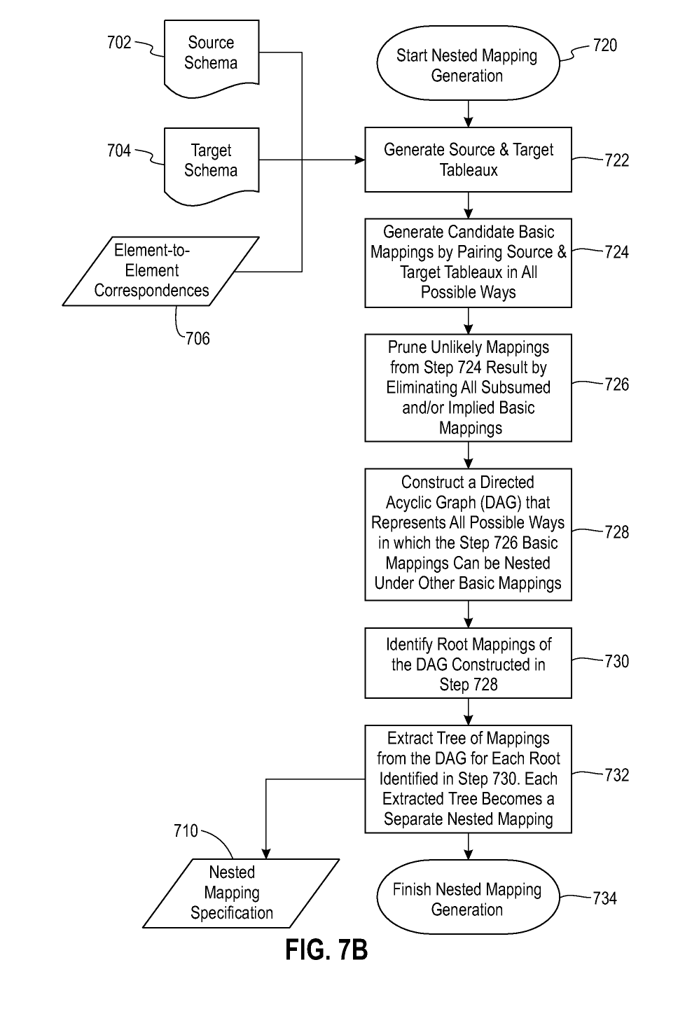

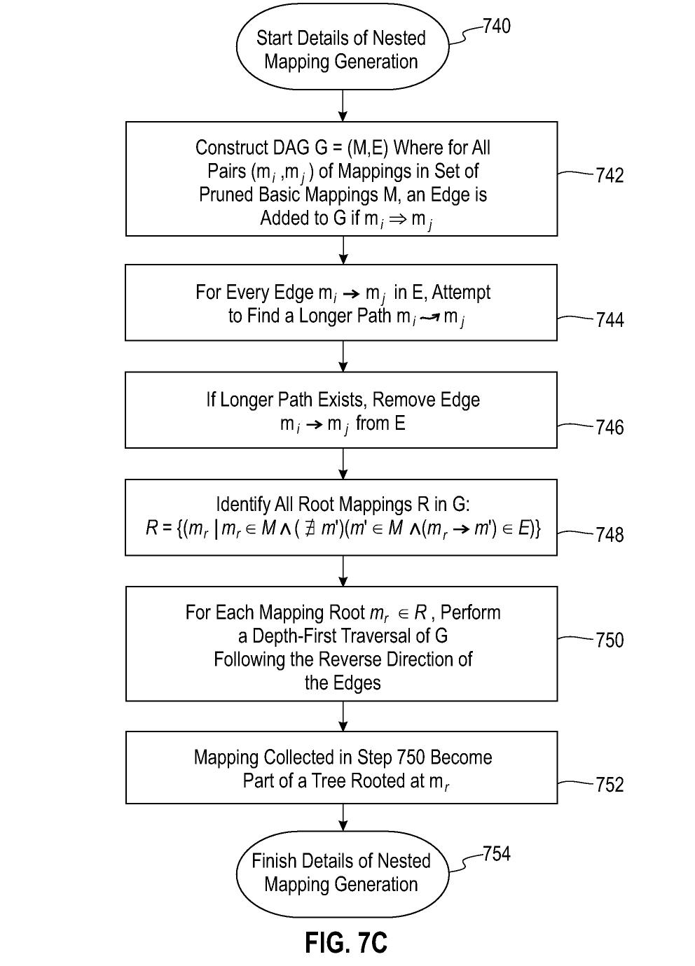

FIG. 7A is a block diagram of a system for generating a nested mapping specification and for generating a transformation query that uses the generated nested mapping specification as input. System 700 includes input of a source schema 702, a target schema 704 and a set of correspondences 706 between atomic elements in source schema 702 and atomic elements in target schema 704. Input 702, 704, 706 is received by a nested mapping generator 708 that generates a nested mapping specification 710 as output. Nested mapping specification 710 is then used as input to a transformation query generator 712 that outputs a transformation query script 714. Although FIG. 7A depicts a single source schema 702, the present invention contemplates other embodiments in which system 700 includes multiple source schemas that are input into nested mapping generator 708 and that are associated with target schema 704. Hereinafter, any reference to a single source schema (e.g., “source schema 702” or “the source schema”) may be replaced with multiple source schemas associated with target schema 704.

FIG. 7B is a flow diagram of a process for generating a nested mapping specification. The nested mapping specification generation process begins at step 720. In step 722, nested mapping generator 708 (see FIG. 7A) takes as input source schema 702, target schema 704 and element-to-element correspondences 706 and generates source and target tableaux. The details of generating the source and target tableaux are included in a subsection presented below entitled “Step 1. Computation of Tableaux” in Section 3.1. In step 724, the nested mapping generator generates candidate basic mappings by pairing source and target tableaux in all possible ways. The details of step 724 are described in a subsection presented below entitled “Step 2. Generation of basic mappings” in Section 3.1. In step 726, the nested mapping generator prunes unlikely mappings from the candidate basic mappings generated in step 724 by eliminating all subsumed and/or implied basic mappings. The details of this pruning step are included in the subsection presented below entitled “Step 3. Pruning of basic mappings” in Section 3.2.

In step 728, the nested mapping generator constructs a directed acyclic graph (DAG) that represents all possible ways in which the basic mappings remaining after the step 726 pruning can be nested under other basic mappings. In step 730, the nested mapping generator identifies root mappings of the DAG constructed in step 728. In step 732, the nested mapping generator extracts a tree of mappings from the DAG for each root identified in step 730. Each extracted tree becomes a separate nested mapping in an outputted nested mapping specification 710. The process of FIG. 7B ends at step 734.

Steps 728, 730 and 732 are further described in the subsection presented below that is entitled “Step 4. Generation of nested mappings” in Section 3.4. Details of steps 728, 730 and 732 are also included in the nested mapping generation process of FIG. 7C.

### 3.1 Basic Mapping Generation

This section reviews the generation algorithm for basic mappings. The main concept is that of a tableau. Tableaux are a way of describing all the basic concepts and relationships that exist in a schema. As used herein, a concept is defined as a category of data that can exist in a schema. There is a set of tableaux for the source schema and a set of tableaux for the target schema. Each tableau is primarily an encoding of one concept of a schema. In addition, each tableau includes all related concepts; that is, concepts that must exist together according to the referential constraints of the schema or the parent-child relationships in the schema. This inclusion of all related concepts allows the subsequent generation of mappings that preserve the basic relationships between concepts. Such preservation is one of the main properties of the basic mapping generation algorithm, and continues to apply to the new algorithm for generating nested mappings.

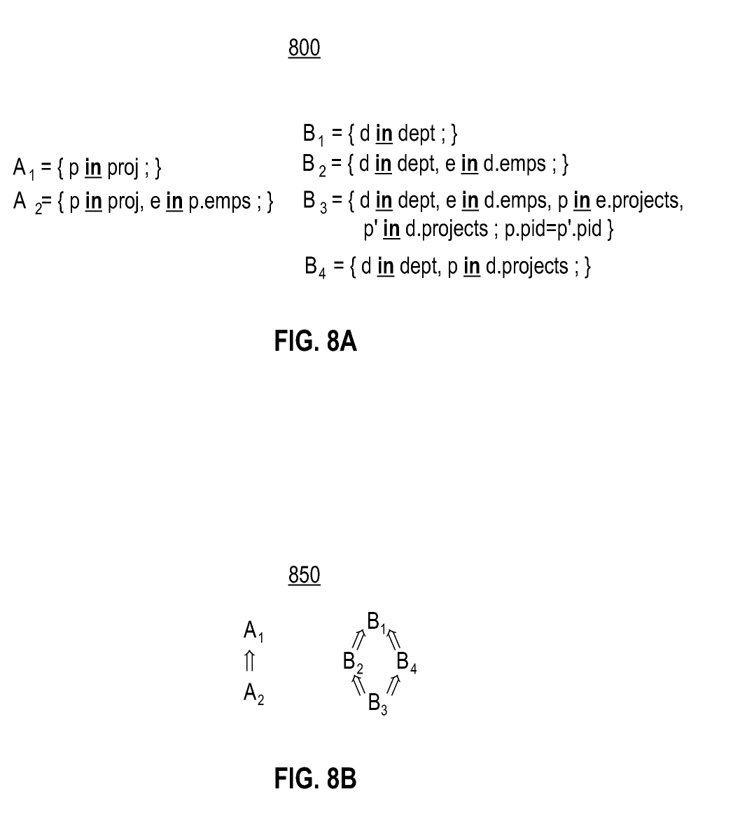

Step 1. Computation of tableaux: This step is also referred to herein as step 722 of FIG. 7B. Given the two schemas, the sets of tableaux are generated as follows. For each set type T in a schema, first a primary path is created that spells out the navigation path from the schema root to elements of T. For each intermediate set, there is a variable to denote elements of the intermediate set. To illustrate, recall the earlier schemas in FIG. 3. In FIG. 8A, A₁ and A₂ are primary paths corresponding to the two set types associated with proj and emps in the source schema. Note that in A₂, the parent set proj is also included, since it is needed in order to refer to an instance of emps. Similarly, B₁, B₂, and B₄ are primary paths in the target.

In addition to the structural constraints (i.e., parent-child) that are part of the primary paths, the computation of tableaux also tales into account the integrity constraints that may exist in schemas. For the example in Section 3, the target schema includes the following constraint, which is similar to a keyref in an XML Schema: every project id of an employee within a department must appear as the id of a project listed under the department. This constraint is explicitly enforced in the tableau B₃ in FIG. 8A. The tableau is constructed by enhancing, via the chase with constraints, the primary path B′₃ that corresponds to the set type projects under emps:

B′₃={d in dept, e in d.emps, p in e.projects;}

The tableau B₃ encodes that the concept of a project-of-an-employee-of-a-department requires the following concepts to exist: the concept of an employee-of-a-department, the concept of a department, and the concept of a project-of-a-department.

For each schema, the set of its tableaux is obtained by replacing each primary path with the result of its chase, with all the applicable integrity constraints. For the example in Section 3, only one primary path is changed by the chase (i.e., changed into B₃). The rest remain unchanged, since no constraints are applicable. For each tableau, for mapping purposes, all the atomic type elements that can be referred to from the variables in the tableau are considered. For example, B₃ includes dname, budget, ename, salary, pid, and pname. Such elements are referred to herein as being covered by the tableau. As used herein, generators are the variable bindings that appear in a tableau. Thus, a tableau consists of a sequence of generators and a conjunction of conditions. Note that only one pid is included, since p.pid is equal to p′.pid.

Step 2. Generation of basic mappings: In the second step of the algorithm (i.e., step 724 of FIG. 7B), basic mappings are generated by pairing in all possible ways the source and the target tableaux that were generated in the first step. For each pair (A, B) of tableaux, let V be the set of all correspondences for which the source element is covered by A and for which the target element is covered by B. For the example in Section 3, if the pair (A₁, B₁) is considered, then V consists of one correspondence: dname to dname, identified by d in FIG. 3. If the pair (A₁, B₄) is considered, then there is one more correspondence covered: pname to pname (i.e., p).

Every triple (A, B, V) encodes a possible basic mapping: the for and the associated where clause are given by the generators and the conditions in A, the exists clause is given by the generators in B, and the subsequent where clause includes all the conditions in B along with conditions that encode the correspondences (i.e., for every v in V, there is an equality between the source element of v and the target element of v). Herein, the basic mapping represented by (A, B, V) is written as ∀A→∃B.V, with the meaning described above. For the example in Section 3, the basic mapping ∀A₁→∃B₄.{d,p} is precisely the mapping m₁ of FIG. 3. Also, the basic mapping ∀A₂→∃B₃.{d, p, e, s} is the mapping m₂ of FIG. 3.

Among all the possible triples (A, B, V), not all of them generate actual mappings. A basic mapping is generated only if it is not subsumed and not implied by other basic mappings. This optimization procedure is described in Section 3.2.

### 3.2 Subtableaux and Optimization

The following concept of subtableau plays an important role in reasoning about basic mappings, and in particular in pruning out unlikely mappings during generation (see Step 3 presented below). The same concept also turns out to be very useful in the subsequent generation of nested mappings.

DEFINITION 3.1. A tableau A is a subtableau of a tableau A′, denoted by A≦A′, if (1) the generators in A form a superset of the generators in A′, possibly after some renaming of variables and (2) the conditions in A are a superset of the conditions in A′ or the conditions in A imply the conditions in A′, modulo the renaming of variables. Herein, A is referred to as a strict subtableau of A′ with the notation A<A′ if A≦A′ and the generators in A form a strict superset of the generators in A′.

For each schema, the subtableau relationship induces a directed acyclic graph of tableaux, with an edge from A to A′ whenever A≦A′. Such a graph can be seen as a hierarchy where the tableaux that are smaller in size are at the top. The tableaux at the top correspond to the more general concepts in the schema, while those at the bottom correspond to the more specific ones. Although the subtableau relationship is reflexive and transitive, most of the time the “direct” subtableau edges are considered. For the example in Section 3, the two hierarchies with no transitive edges are shown in FIG. 8B.

Step 3. Pruning of basic mappings: Step 3 (a.k.a. step 726 of FIG. 7B) completes the algorithm for the generation of basic mappings with an additional step that prunes unlikely mappings. This step is especially important because it reduces the number of candidate mappings that the nesting algorithm will have to explore.

A basic mapping ∀A→∃B.V is subsumed by a basic mapping ∀A′→∃B′.V′ if A and B are respective subtableaux of A′ and B′, with at least one being strict, and V=V′. Note that if A and B are respective subtableaux of A′ and B′, then necessarily V includes V′ since A and B cover all the atomic elements that are covered by A′ and B′, and possibly more. The subsumption condition says that (A, B, V) should not be considered since it covers the same set of correspondences that are covered by the smaller and more general tableaux A′ and B′. For the example of FIG. 3, ∀A₁→∃B₂.{d} is subsumed by ∀A₁→∃B₁.{d}.

A basic mapping may be logically implied by another basic mapping. Testing logical implication of basic mappings can be done using the chase, since basic mappings are tuple-generating dependencies, albeit extended over a hierarchical model. Although in one embodiment, the chase is used for completeness, in another embodiment a simpler test suffices: a basic mapping m is implied by a basic mapping m′ whenever m is of the form ∀A→∃B.V and m′ is of the form ∀A→B′.V′ and B′ is a subtableau of B. All the target components, with their equalities, that are asserted by m are asserted by m′ as well, with the same equalities. As an example, ∀A₁→∃B₁.{d} is implied by ∀A₁→∃B₄.{d, p}.

Note that subsumption also eliminates some of the implied mappings. In the aforementioned definition of subsumption, in the particular case when B and B′ are the same tableaux, the subsumed mapping is also implied by the other one. For example, ∀A₂→∃B₁.{d} is subsumed and implied by ∀A₁→∃B₁.{d}.

The generation algorithm for basic mappings stops after eliminating all the subsumed and implied mappings. For the example in Section 3, only the two basic mappings, m₁ and m₂, remain from FIG. 3.

### 3.3 When is a Basic Mapping Nestable?

This section provides a formal definition of the notion of a basic mapping being nestable under another basic mapping. This definition follows the intuition given in Section 2.2: m₂ is nested inside m₁ if m₁ is “part” of m₂; moreover, the nesting is done by factoring out the common part (i.e., m₁) and adding the “remainder” of m₂ as a submapping. Based on this definition, a graph (i.e., hierarchy) of basic mappings is constructed that will be used by the actual generation algorithm, which is described in Section 3.4.

DEFINITION 3.2. A basic mapping ∀A₂→∃B₂.V₂ is nestable inside a basic mapping ∀A₁→∃B₁.V₁ if the following conditions hold:

(1) A₂ and B₂ are strict subtableaux of A₁ and B₁, respectively,
(2) V₂ is a strict superset of V₁, and
(3) there is no correspondence v in V₂−V₁ whose target element is covered by B₁.

For the example in Section 3, the basic mapping m₂=∀A₂→∃B₃.{d, p, e, s} is nestable inside m₁=∀A₁→∃B₄.{d, p}. In particular, A₂ and B₃ are strict subtableaux of A₁ and B₄; also, there are two correspondences in m₂ but not in m₁ (i.e., e and s) and their target elements are not covered by B₄.

DEFINITION 3.3. Let m₂=∀A₂→∃B₂.V₂ be nestable inside m₁=∀A₁→∃B₁.V₁. Without loss of generality, assume that all variable renamings have been applied so that the generators in A₁ (B₁) are literally a subset of those in A₂ (B₂). The result of nesting m₂ inside m₁ is a nested mapping of the form:

∀A₁→∃B₁.[V₁ [symbol] ∀(A₂−A₁)→∃(B₂−B₁).(V₂-V₁)]

where ∀(A₂−A₁)→∃(B₂−B₁).(V₂-V₁) is a shorthand for a submapping constructed as follows. The for clause contains the generators in A₂ that are not in A₁. The subsequent where clause, if needed, contains all the conditions in A₂ that are not among and not implied by the conditions of A₁. The exists clause and subsequent where clause satisfy similar properties with respect to B₂ and B₁. Finally, the last where clause also includes the equalities encoding the correspondences in V₂-V₁.

It can easily be verified that, for the example in Section 3, the result of nesting m₂ inside m₁ is precisely the nested mapping n. Next conditions (1) and (3) in Definition 3.2 are explained. Assume that m₂ and m₁ are as presented in Definition 3.2. The condition that A₂ is a strict subtableau of A₁ ensures that the for clause in the submapping that appears in the result of nesting m₂ inside m₁ is non-empty.

Assume now that B₂ is not a strict subtableau of B₁ and it is equal to B₁. Note that the case when there are additional conditions in B₂ does not affect this discussion. Then, the submapping that appears in the result of nesting of m₂ inside m₁ is a formula of the form: ∀(A₂−A₁)→(V₂−V₁) (i.e., the equalities on the right-hand side are implied by the left-hand side). There is at least one correspondence v in V₂−V₁, and its source element is not covered by A₁; otherwise it would be in V₁. Hence, in the right-hand side of the aforementioned implication, there is at least one equality asserting that a target element covered by B₁ is equal to a source element covered by A₂−A₁. The problem with this is that there are many instances of such a source element for one instance of the target element, since B₁ is outside the scope of V(A₂−A₁). This constraint would effectively require that all such instances of the source element be equal, and equal to the one instance of the target element. Such a constraint is unlikely to be desired, even when it is satisfiable. Although condition (3) of Definition 3.2 is a bit more subtle, a careful analysis yields a similar justification.

This discussion is illustrated by considering the reverse of the mapping scenario shown in FIG. 3. The schema on the right of FIG. 3 is now the source schema, while the schema on the left is the target schema. The correspondences are the same. Also, the tableaux remain the same as in FIGS. 8A-8B, with the difference that B₁, B₂, B₃, B₄ are now source tableaux, and A₁ and A₂ are target tableaux.

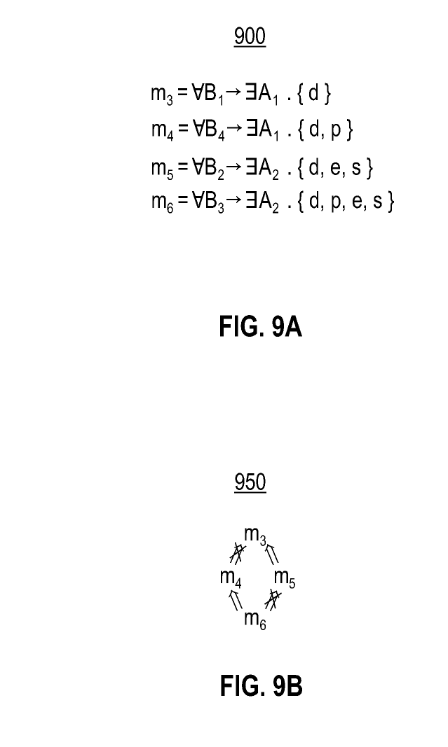

There are four basic mappings (i.e., not implied and not subsumed) that are generated by the algorithm described in Section 3.1. These mappings are shown in FIG. 9A. For the group of mappings in FIG. 9A, m₅ is nestable inside m₃ and m₆ is nestable inside m₄. However, m₄ is not nestable inside m₃ because the target tableaux are the same. Similarly, m₆ is not nestable inside m₅. FIG. 9B illustrates these “nestable” and “not nestable” relationships between mappings. Upon attempting to nest m₄ inside m₃, the following nested mapping is obtained:

n₃₄: for d in dept [symbol] exists p′ in proj where p′.dname=d.dname [symbol] (for p in d.projects [symbol] p′.pname=p.pname)

This constraint says that if there are multiple projects in one dept tuple, which is possible according to the source schema, then all these projects are required to have the same pname value, which must also equal the pname value in the corresponding target proj tuple. This puts a constraint on the source data that is unlikely to be satisfied. In the nested mapping generation algorithm of the present invention, mappings such as n₃₄ are not generated.

3.4 Nesting Algorithm In the next step (i.e., Step 4) of the algorithm, the nestable relation of Definitions 3.2 and 3.3 is used to create a set of nested mappings. The input to Step 4 is the set of basic mappings that result after Step 3 (i.e., the set of basic mappings that remain after the pruning in step 726 of FIG. 7B).

Step 4. Generation of nested mappings: In this step (a.k.a. steps 728, 730 and 732 of FIG. 7B or the detailed nested mapping generation process of FIG. 7C), the algorithm starts at step 740 of FIG. 7C and first constructs a DAG G=(M, E) (i.e., in step 728 of FIG. 7B and step 742 of FIG. 7C) that represents all possible ways in which the basic mappings resulting from step 3 (i.e., step 726 of FIG. 7B) can be nested under other basic mappings. Here, M is the set of basic mappings generated in Step 3, while E contains edges m₁→mⱼ with the property that mᵢ is nestable under mⱼ according to Definition 3.2. To create nested mappings out of G, the root mappings of G are identified in step 730 of FIG. 7B and a tree of mappings is extracted from G for each root in step 732 of FIG. 7B. Each such extracted tree of mappings becomes a separate nested mapping.

To understand the shape of G and the issues involved in its construction, the properties of the nestable relation of Definition 3.2 are examined herein. Given two basic mappings mᵢ and mⱼ, let mᵢ [symbol] mⱼ denote that mᵢ is nestable inside mⱼ. The following properties are noted:

(1) The nestable relation is not reflexive and not symmetric. In fact, stronger statements hold: (a) for all mᵢ, mᵢ [symbol] mᵢ, and (b) if mᵢ [symbol] mⱼ, then mⱼ [symbol] mᵢ. This property follows from the strict subtableaux requirement in condition (1) of Definition 3.2.

(2) The nestable relation is transitive: if mᵢ [symbol] mⱼ and mⱼ [symbol] mₖ then mᵢ [symbol] mₖ. This property again follows from condition (1) of Definition 3.2 and, further, from conditions (2) and (3) of Definition 3.2.

Because of two properties described above, G is necessarily acyclic. If there is a path mᵢ [symbol] mⱼ in G, then no path mⱼ [symbol] mᵢ exists in G. Condition (2) indicates that a naive algorithm for creating G might add too many edges and hence form unnecessary nestings. Indeed, suppose that mᵢ [symbol] mⱼ and mⱼ [symbol] mₖ, which also implies that mᵢ [symbol] mₖ. Then mᵢ can be nested under mⱼ which can be nested under mₖ. At the same time, mᵢ can be nested directly under mₖ. One embodiment prefers the former, deeper, nesting strategy because that interpretation preserves all source data together with its structure.

To illustrate this point, consider the mapping in FIG. 1, in which m₃ [symbol] m₂ [symbol] m₁, and also m₃ [symbol] m₁. Using the deepest nesting results in a nested mapping with the following pattern: first map dept tuples, then map the emps tuples under the current dept tuple, and then map the dependents tuples of the current emps tuple. The other interpretation, obtained by nesting m₃ directly inside m₁, is not semantically equivalent to the first one. Indeed, this second interpretation maps all dept tuples but then, for each dept tuple, it maps the join of emps and dependents tuples. Thus, emps tuples with no dependents are not mapped. In order not to lose data, this second interpretation is fixed by nesting both m₂ and m₃ directly inside m₁, using the fact that m₂ [symbol] m₁ and m₃ [symbol] m₁. This would have the effect of mapping all tuples of emps. However, this choice still does not model any correlation between the two submappings m₂ and m₃. Hence, there is no merging of employee tuples and no grouping of dependents within employees. The first interpretation solves the issue by utilizing, intuitively, all the available nesting.

To implement the above nesting strategy, which performs the “deepest” nesting possible, the algorithm for constructing G makes sure not to include any transitively implied edges. More formally, the DAG G=(M, E) of mappings is constructed so that its set of edges satisfies the following:

E={(mᵢ→mⱼ)|mᵢ [symbol] mⱼ [symbol] ( [symbol] mₖ)(mᵢ [symbol] mₖ [symbol] mₖ [symbol] mⱼ)}

The creation of G proceeds in two steps. First, in step 742 of FIG. 7C, for all pairs (mᵢ, mⱼ) of mappings in M, an edge is added to G if mᵢ [symbol] mⱼ. Then, in step 744 of FIG. 7C, for every edge mᵢ→mⱼ in E, an attempt is made to find a longer path mᵢ [symbol] mⱼ. If such a path exists, mᵢ→mⱼ is removed from E in step 746 of FIG. 7C. This process to create G is implemented using a variation of the all-pairs shortest-path algorithm, except this process looks for the longest path and its complexity is O(|M|³).

The next step is to extract trees of mappings from G. Each such tree becomes a nested mapping expression. These trees are computed in two simple steps. First, in step 748 of FIG. 7C, all root mappings R in G are identified: R={mᵣ|mᵣ∃M [symbol] ( [symbol] m′)(m′∃M [symbol] (mᵣ→m′)∃E)}. Second, in step 750 of FIG. 7C, for each root mapping mᵣ∃R, a depth-first traversal of G is done following the reverse direction of the edges. Mappings collected during this visit become part of the tree rooted at mᵣ in step 752 of FIG. 7C, and the detailed nested mapping generation process ends at step 754 of FIG. 7C.

Constructing nested mappings from a tree of mappings raises several issues. First, Definition 3.3 explained the meaning of nesting two basic mappings, one under the other. But, in a tree, one mapping can have multiple children that can each be nested inside the parent. Also, the definition must be applied recursively.

The second, more important issue is that, since these trees are extracted from a DAG, it is possible that they share mappings. In other words, a mapping can be nested under more than one mapping.

Consider, for example, a mapping scenario that involves three sets: employees, worksOn, and projects. The worksOn set contains references to employees and projects tuples, capturing an N:M relationship. Assume that mₑ is a basic mapping for employees, mₚ is a basic mapping for projects, and m_{w} is a basic mapping that maps employees and projects by joining them via worksOn. The resulting graph G of mappings contains two mapping trees (i.e., two nested mappings), which both yield valid interpretations: T₁={mₑ [symbol] m_{w}} and T₂{mₚ [symbol] m_{w}}. Both trees share m_{w} as a leaf. If only one tree is arbitrarily used and the other is ignored, then source data can be lost: the nested mapping based on T₁ maps all the employees; however, it maps only projects that are associated with an employee via worksOn. The situation is reversed for T₂.

However, the inclusion of the shared subtrees in all their “parent” trees will create nested mappings that lead to redundancy in execution as well as in the generated data. To avoid this, a simple strategy is adopted to keep a shared subtree in only one of the parent trees and prune it from all the others. For the example in Section 3, T₁ is kept intact and the common subtree is cut from T₂, yielding T′₂={mₚ}. In general, however, the algorithm should not make a choice of which trees to prune and which to keep intact. This is a semantic and application-dependent decision. The various choices lead to inequivalent mappings that do not lose data but give preference to certain correlations in the data (e.g., group projects by employees as opposed to grouping employees by projects). Furthermore, there can be differences in the performance of the subsequent execution of the data transformation.

Ideally, a human user could suggest which mapping to generate, if exposed to all the possible choices of mappings with shared submappings. One embodiment implements a strategy that selects one of the pruning choices whenever there is such choice, but another embodiment allows users to explore the space of such choices.

### 4. Query Generation

One of the main reasons for creating mappings is to be able to automatically create a query or program that transforms an instance of the source schema into an instance of the target schema. Previous works described how to generate queries from basic mapping specifications. Those works are extended herein to address nested mappings. Because the queries generated by the process described herein start from the more expressive nested mapping specification, these queries often perform better, have more functionality in terms of grouping and restructuring, and at the same time are closer to the mapping specification and therefore easier to understand.

Section 4.1 presents a general query generation algorithm that works for nested mappings with arbitrary Skolem functions for the set elements, and hence for arbitrary regrouping and restructuring of the source data. Section 4.2 presents an optimization that simplifies the query and significantly improves performance in the case of nested mappings with default Skolemization, which are the mappings that produced with the nested mapping generation algorithm described herein. In particular, the optimization of Section 4.2 greatly impacts the scenarios in which no complex restructuring of the source is needed. Many schema evolution scenarios follow this pattern.

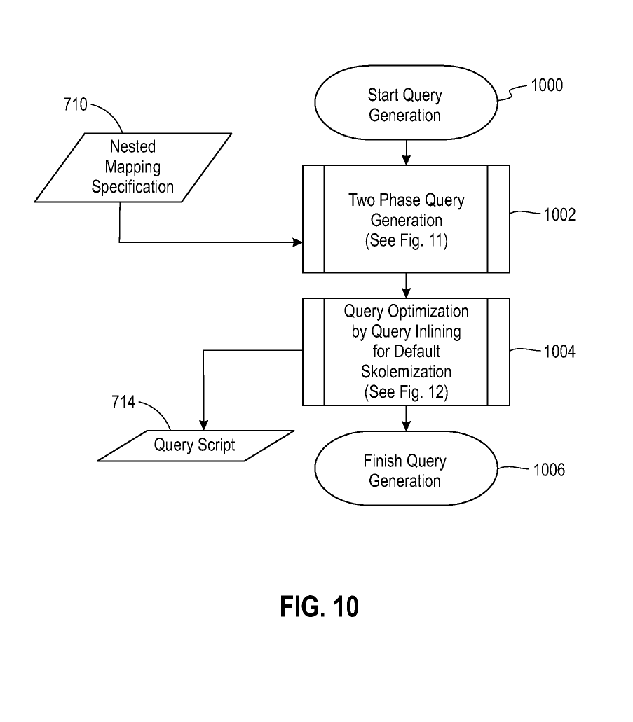

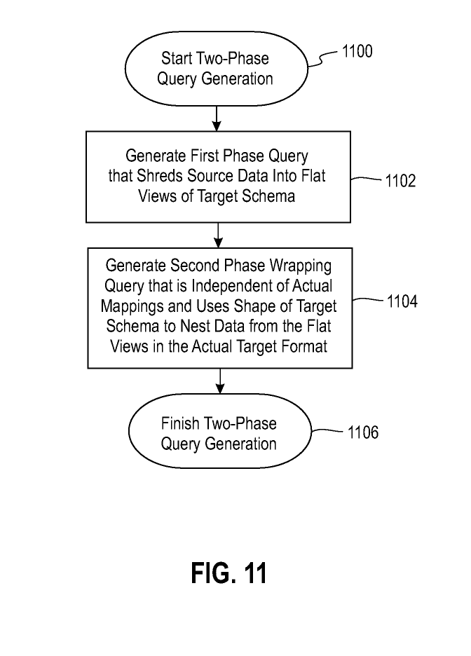

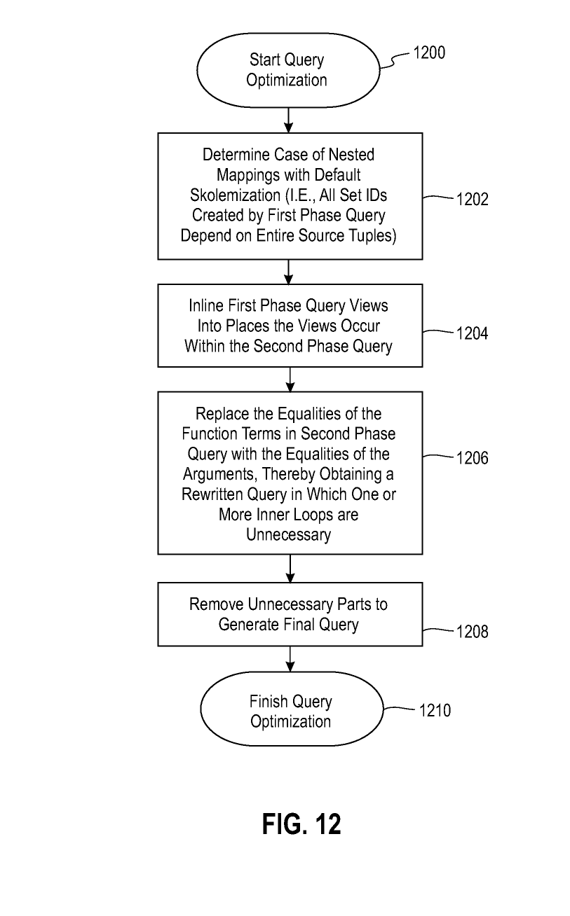

FIG. 10 is a flow diagram of a process for generating a transformation query that uses a nested mapping specification as input. The query generation process begins at step 1000 with nested mapping specification 710 received as input by query generator 712 (see FIG. 7A). The query generator begins a two-phase query generation process in step 1002. Following the generation of a transformation query in step 1002, the generated transformation query is optimized in step 1004 by query inlining for default Skolemization. The output of step 1004 is transformation query script 714 and the query generation process ends at step 1006. The details of step 1002 are included below in Section 4.1 and in FIG. 11. Furthermore, the details of step 1004 are included in Section 4.2 and in FIG. 12.

### 4.1 Two-Phase Query

The general algorithm for query generation produces queries that process source data in two phases. This query generation algorithm starts at step 1100 of FIG. 11. In step 1102, query generator 712 (see FIG. 7A) generates a first-phase query. Also in step 1102, the first-phase query shreds source data into flat or relational views of the target schema. The definition of the first-phase query is based on the target schema and on the information encoded in the mappings. In step 1104, the query generator generates a second-phase query. The second-phase query is a wrapping query that is independent of the actual mappings and uses the shape of the target schema to nest the data from the flat views in the actual target format. Following the generation of the first-phase and second-phase queries, the query generation algorithm ends at step 1106.

First-phase query: This subsection describes the step 1102 construction of the flat views and of the first-phase query. For each target set type for which there is a mapping that asserts some tuple for the mapping, there is a view, with an associated schema and a query defining the view. To illustrate, consider an example (a.k.a. the example in Section 4.1) that includes the schemas of FIG. 3 and the aforementioned nested mapping n. The view schema for the example in Section 4.1 includes the following definitions:
dept(dname, budget, empsID, projectsID)
emps(setID, ename, salary, projects1ID)
projects1(setID, pid)
projects(setID, pid, pname)

As it can be seen, the view for each set type includes the atomic type elements that are directly under the set type. Additionally, setID columns are included for each of the set types that are directly nested under the given set type. Finally, for each set type that is not top-level there is an additional column setID. In the view schema example presented above, dept is the only top-level set type. Using emps to illustrate, the need for the additional setID column is explained as follows: While in the target schema there is only one set type emps, in an actual instance there may be many sets of employee tuples, nested under the various dept tuples. However, the tuples of these nested sets will all be mapped into one single table (i.e., emps). In order to remember the association between employee tuples and the sets they belong to, the setID column is used to record the identity of the set for each employee tuple. This setID column is later used to join with the empsID column under the “parent” table dept, to construct the correct nesting.

This subsection next describes the queries defining the views and how these queries are generated. The query generation algorithm starts by Skolemizing each nested mapping and decoupling it into a set of single-headed constraints, each consisting of one implication and one atom in the right-hand side of the implication. For the example in Section 4.1, the nested mapping n generates the following four constraints (i.e., one constraint for each target atom in n):

r₁:proj(d,p,E₀)→dept(d,null,E[d,p,E₀],P[d,p,E₀])

r₂:proj(d,p,E₀)→P[d,p,E₀](X[d,p,E₀],p)

r₃:proj(d,p,E₀) [symbol] E₀(e,s)→E[d,p,E₀](e,s,P′[d,p,E₀,e,s])

r₄:proj(d,p,E₀) [symbol] E₀(e,s)P′[d,p,E₀,e,s](X[d,p,E₀])

Skolemization replaces every existentially-quantified variable by a Skolem function that depends on all the universally-quantified variables that appear before the existential variable in the original mapping. For example, the atomic variable ?x along with all of its occurrences is replaced by X[d, p, E₀], where X is a new Skolem function name. That is, E₀ is the set id and not the contents. Thus, the Skolem function does not depend on the actual values under E₀. Atomic variables that do not play an important role (e.g., not a key or a foreign key) can be replaced by null (see ?b presented above). Finally, all existential set variables are replaced by Skolem terms if they are not already given by the mapping. Each of the four constraints presented above can be seen as an assertion of “facts” that relate tuples and set ids. For example, r₃ shown above asserts a fact relating the tuple (e, s, P′[d, p, E₀, e, s]) and the set id E[d, p, E₀].

Next, the queries defining the contents of the flat views have the role of storing the facts asserted by the above constraints into the corresponding flat views. For example, all the facts asserted by r₃ are stored into emps, where the setID column is used to store the set ID, as explained earlier. The following is the set of query definitions for the aforementioned four views:

| | |
|---|---|
| let dept := | for p in proj |
| | return [dname = p.dname, |

budget = null,
empsID = E[p.dname, p.pname, p.emps],
projectsID = P[p.dname, p.pname, p.emps]]

| | |
|---|---|
| emps := | for p in proj, e in p.emps |
| | return [ setID = E[p.dname.p.pname,p.emps], |

ename = e.ename,
salary = e.salary,
projects1ID = P′[p.dname, p.pname, p.emps,

e.ename, e.salary]]

| | |
|---|---|
| projects1 := | for p in proj, e in p.emps |
| | return [setID = P′[p.dname, p.pname, p.emps, |

e.ename, e.salary]],

pid = X[p.dname, p.pname, p.emps]],

| | |
|---|---|
| projects := | for p in proj |
| | return [ setID = P[p.dname,p.pname,p.emps], |

pid = X[p.dname, p.pname, p.emps]],
pname = p.pname]

Note that if multiple mappings contribute tuples to a target set type, then each such mapping will contribute with a query expression and the corresponding view is defined by the union of all these query expressions. In the case in which the same Skolem function is used from multiple mappings to define the same set instance (e.g., as discussed in Section 2.3), then the union of queries defining the view will effectively accumulate all the tuples of this set instance within the view. Moreover, all these tuples will have the same set id.

Second-phase query: Finally, in step 1104, the previously defined views are used within a query (see q presented below) that combines and nests the data according to the shape of the target schema. Notice that the nesting of data on the target is controlled by the Skolem function values computed for the set id columns in the views.

(q) dept = for d in dept

return [

```
  dname = d.dname,
  budget = d.budget,
  emps = for e in emps
```

where e.setID = d.empsID
return [

```
  ename = e.ename,
  salary = e.salary,
  projects = for p in projects1
```

where p.setID = e.projects1ID
return [ pid = p.pid ]],

projects = for p in projects

where p.setID = d.projectsID
return [ pid = p.pid,

pname = p.pname ] ]

### 4.2 Query Inlining for Default Skolemization

The two-phase query generation algorithm of Section 4.1 is general in the sense that it can work for arbitrary restructuring of the data. However, the query generation algorithm of Section 4.1 does require the data to be flattened before being re-nested in the target format. In cases in which the source and target schemas have similar nesting shape and the grouping behavior given by the default Skolem functions is sufficient, the two-phase strategy can be inefficient. In such cases, a query optimization process of FIG. 12 generates a simplified query that significantly improves query performance.

The query optimization process begins at step 1200. In step 1202, query generator 712 (see FIG. 7A) determines the existence of a case of nested mappings with default Skolemization. That is, all set IDs created by the first-phase query generated in step 1102 (see FIG. 11) depend on entire source tuples. In step 1204, the first-phase query views are inlined into places the views occur within the second-phase query generated in step 1104 (see FIG. 11). Inlining is described in the query optimization example that follows. In step 1206, the query generator replaces the equalities of the function terms in the second-phase query with the equalities of the arguments, thereby obtaining a rewritten query in which one or more inner loops are unnecessary (i.e., redundant). In step 1208, the unnecessary parts obtained in step 1206 are removed. The query optimization process ends at step 1210.

For example, the nested mapping n used in Section 4.1 falls in the category of nested mappings with default Skolemization, as determined by step 1202. Under default Skolemization, all the set ids that are created (i.e., created by the first-phase query) depend on entire source tuples rather than individual pieces of these tuples. To illustrate, the default Skolem function E for emps depends on p.dname, p.pname and p.emps, which is equivalent to saying that E is a function of the source tuple p. Similarly, the Skolem function P for projects under departments depends on p. Also, the Skolem function P′ for projects under employees depends on p.dname, p.pname, p.emps and e.ename and e.salary, which means that P′ is a function of the source tuples p and e. Under such a scenario, the views defined by the first-phase query are inlined in step 1204 into the places where the views occur in the second-phase query. Using the example in Section 4.1 and taking care to rename conflicting variable names, following rewrite of q is obtained:

(q′) dept = for p in proj

```
return [
  dname = p.dname, budget = null,
  emps = for p′ in proj, e in p′.emps
```

```
where E[p] = E[p′]
return [
  ename = e.ename, salary = e.salary,
  projects = for p″ in proj, e′ in p″.emps
```

```
  where P′[p′,e] = P′[p″,e′]
  return [
  pid = X[p″.dname, p″.pname, p″.emps] ] ],
```

projects = for p′ in proj

```
  where  P[p] = P[p′]
  return [ pid = X[p′.dname, p′.pname, p′.emps],
```

pname = p′.pname ] ]

Since the Skolem functions are one-to-one id generators, the equalities of the function terms are now replaced with the equalities of the arguments in step 1206. Thus E[p]=E[p′] is replaced with p=p′. Also, P′[p′, e]=P′[p″, e′] is replaced with the conjunction of p′=p″ and e=e′. Furthermore, P[p]=P[p′] is replaced with p=p′. Hence, a rewriting of q′ is obtained where some of the inner loops are unnecessary. The redundant parts in q′ presented above include: (1) for p′ in proj, and where E[p]=E[p′] following emps=; (2) for p″ in proj, e′ in p″.emps where P′[p′,e]=P′[p″,e′] following the innermost projects=; and (3) for p′ in proj where P[p]=P[p′] following the outermost projects=. The query q′ is then rewritten by removing the declaration of p′ and the self-join condition p=p′. If this is done at all levels where setID equalities are used, then the above-listed redundant parts (1)-(3) of the query can be redacted in step 1208. In some cases, the loops are completely replaced by singleton set expressions—this happens for both proj eats sets in the example in Section 4.1. The final query (i.e., the result of the rewritten query in step 1206 followed by the removal of redundant parts in step 1208) is shown below as q″, which tightly follows the expressions and optimizations encoded in the nested mapping n.

(q″) dept = for p in proj

return [

dname = p.dname, budget = null,
emps = for e in p.emps

return [

ename = e.ename, salary = e.salary,
projects = { [ pid = X[p.dname, p.pname,
p.emps] ] } ],

projects = { [

pid = X[p.dname, p.pname, p.emps],
pname = p.pname ] } ]

### 5. Experiments

A number of experiments were conducted to understand the performance of (a) the nested mapping queries described in Section 4 and (b) the nested mapping creation algorithm of Section 3. The nested mapping prototype described herein is implemented in Java. The experiments were performed on a PC-compatible machine, with a single 2.0 GHz P4 CPU and 1 GB RAM, running Windows XP (SP1) and JRE 1.4.2. Each experiment was repeated three times, and the average of the three trials is reported.

### 5.1 Query Evaluation

First, the performance of queries generated using nested mappings is compared with the performance of queries generated from basic mappings. This comparison focuses on a schema evolution scenario where nested mappings with default Skolemization suffice to express the desired transformation and inlining is applied to optimize the nested mapping query, as described in Section 4.2. A nested schema authorDB was created based on the Digital Bibliography & Library Project (DBLP) structure, but with four levels of nesting. The first level contains an author set. Each author tuple has an attribute name and a nested set of confjournal tuples. Each confjournal tuple has an attribute name and a set of year tuples. Each year tuple contains a yr attribute and a set of pub elements, each with five attributes: pubId, title, pages, cdrom, url.

The basic and nested mapping algorithms were run on four different settings to create four pairs of mappings (i.e., one basic and one nested). Nested schema authorDB was used as the source and target schema and added different sets of correspondences to create the four different settings. In the first, m₁, only the top-level author set was mapped (i.e., only one correspondence between the name attributes of author was used). In the second mapping, the first and the second level of authorDB (i.e., author and confJournal) was mapped. Since levels 1 and 2 were mapped, this mapping is herein referred to as m₁₂. In the same fashion, correspondences were added for the third and fourth levels of authorDB, creating mappings m₁₂₃ and m₁₂₃₄, respectively.

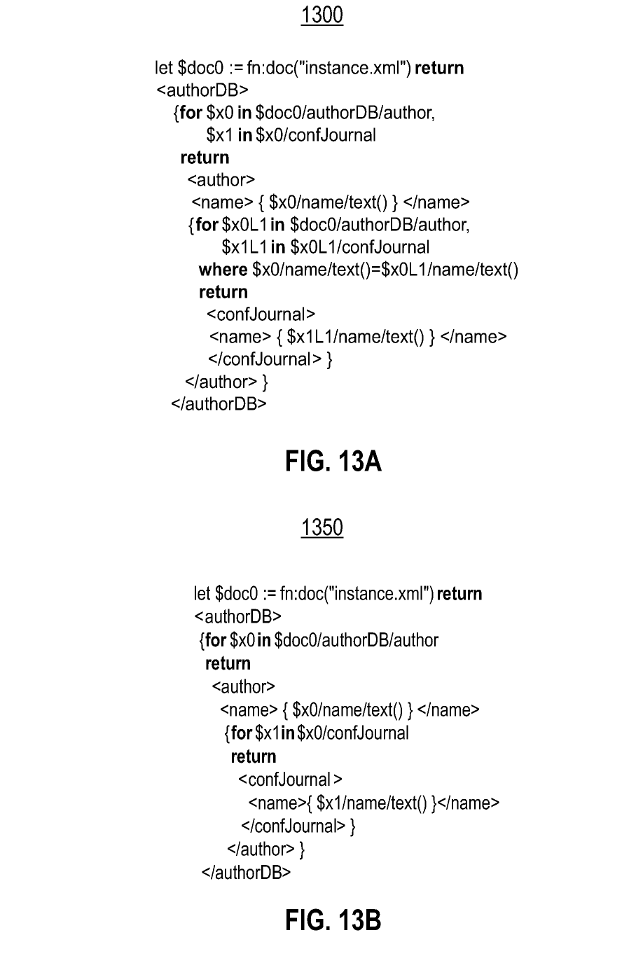

For each mapping, two XQuery scripts were created: one generated using the basic mappings, and another generated from the nested mappings, as described in Sections 4.1 and 4.2. FIGS. 13A-13B compare the generated queries for m₁₂. Relative to m₁₂, FIG. 13A depicts the basic mapping query and FIG. 13B depicts the nested mapping query. To simplify the experiment, input instances were considered where each author has at least one confJournal element under it, and similarly, each confJournal contains at least one year subelement and each year contains at least one pub subelement. As a consequence, only one basic mapping is enough to map all the source data. Otherwise, additional basic mappings would have to be considered (e.g., map author elements independently of the existence of confJournal subelements). This consideration of additional basic mappings would only make the basic mapping query become more complex and have worse performance. On the other hand, even in the favorable case where one basic mapping is enough, the nested mapping query is still shown to be much better.

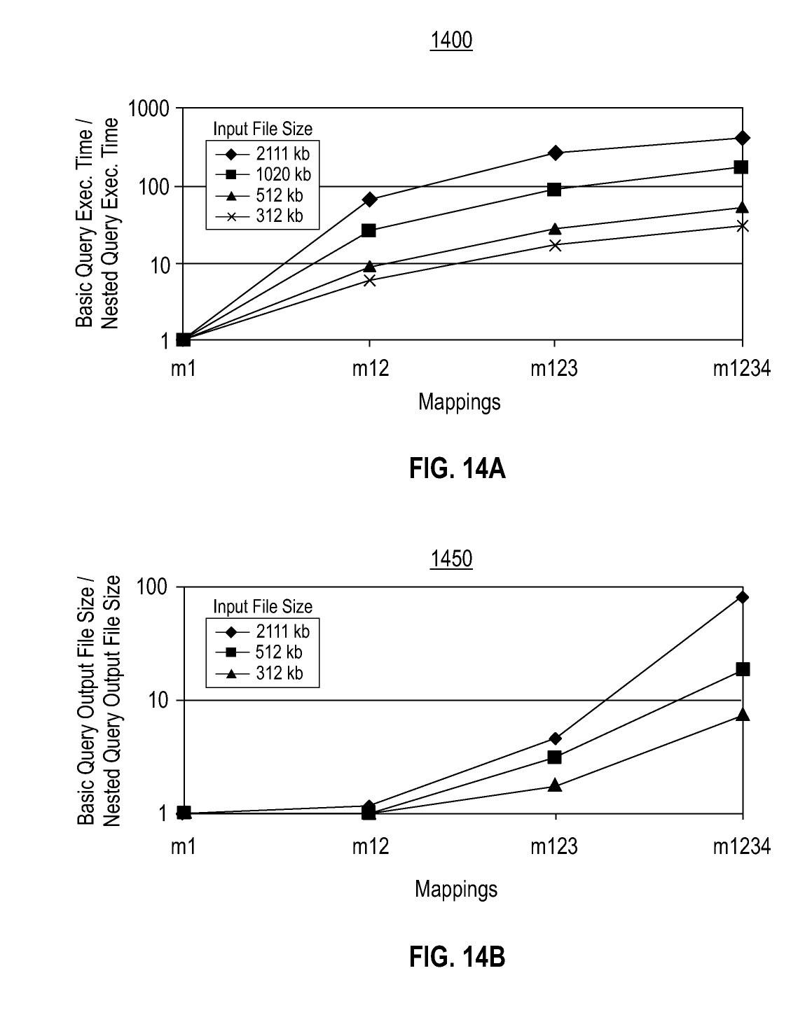

The queries were run using the Saxon XQuery processor with increasingly larger input files. FIGS. 14A-14B show that the nested mapping queries consistently outperformed the basic mapping queries, both in time and in the size of the output instance generated. Note that larger output files for the same mapping indicate more duplicate tuples in the result, FIG. 14A plots the execution speed-up for the nested mapping queries (i.e., the ratio of the execution time for the basic mapping query over the execution time for the query generated with the nested mapping). FIG. 14B shows the ratio of the output file size for the basic mapping over the output file size for the nested mapping. Both charts use a logarithmic scale in the y-axis.

A cursory inspection of the queries in FIGS. 13A-13B reveals the reason for the better execution time of the nested mapping queries. The basic mapping query generation strategy repeats the source tableau expression for each target set type. In the case of m₁₂, the basic mapping query iterates over every source author and confJournal once to create target author elements (i.e., variables x0 and x1 in the query). A second loop is used to compute the nested confJournal elements (i.e., variables x0L1 and x1L1). Further, since only the nesting of the confjournal elements for the current author tuple is desired, the second loop is correlated to the outer one (i.e., the where clause in the query). That is, this basic mapping query requires two passes over the input data plus a correlated nested subquery to correctly nest data. In contrast, the nested mapping query does only one pass over the source author and confjournal data and does not need any correlation condition since it takes advantage of existing nesting of the source data.

The basic mapping query strategy can also create a large number of duplicates in the output instance. To illustrate this problem, a mapping m₁₄ was created that maps the author and pub levels of the schema. The queries for m₁₄ and m₁₂₃₄ were run using an input instance that contains 4173 author elements and a total of 6468 pub elements nested within those authors. The count of resulting author and pub elements in the output instance is shown in this table:

| Mapping | B author | B pub | NM author | NM pub |
|---|---|---|---|---|
| m₁₄ | 6468 | 18826 | 4173 | 6468 |
| m₁₂₃₄ | 6468 | 157254 | 4173 | 6468 |

The nested mapping queries do not create duplicates for any of the two mappings and produce a copy of the input instance, which is the expected output instance in all these mappings. The basic mapping queries, on the other hand, create 2295 duplicate author elements. A duplicate is created whenever an author has more than one publication. Each author duplicate then carries the same set of duplicate publications causing an explosion of duplicate pub elements. The nested mapping query that is automatically generated by the algorithm described herein does not suffer from this common problem.

### 5.2 Algorithm Evaluation

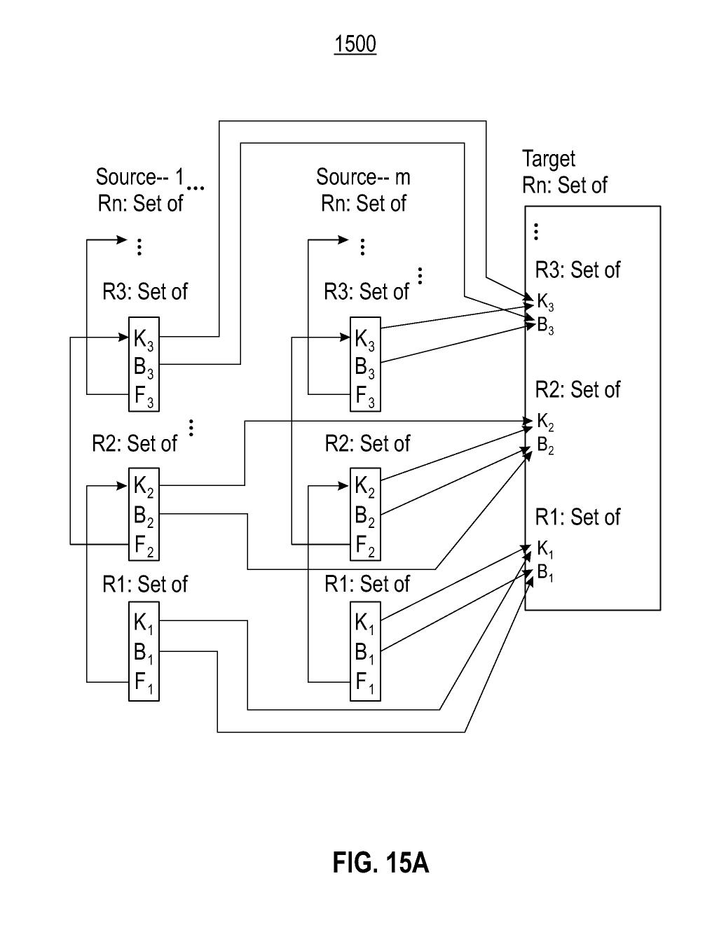

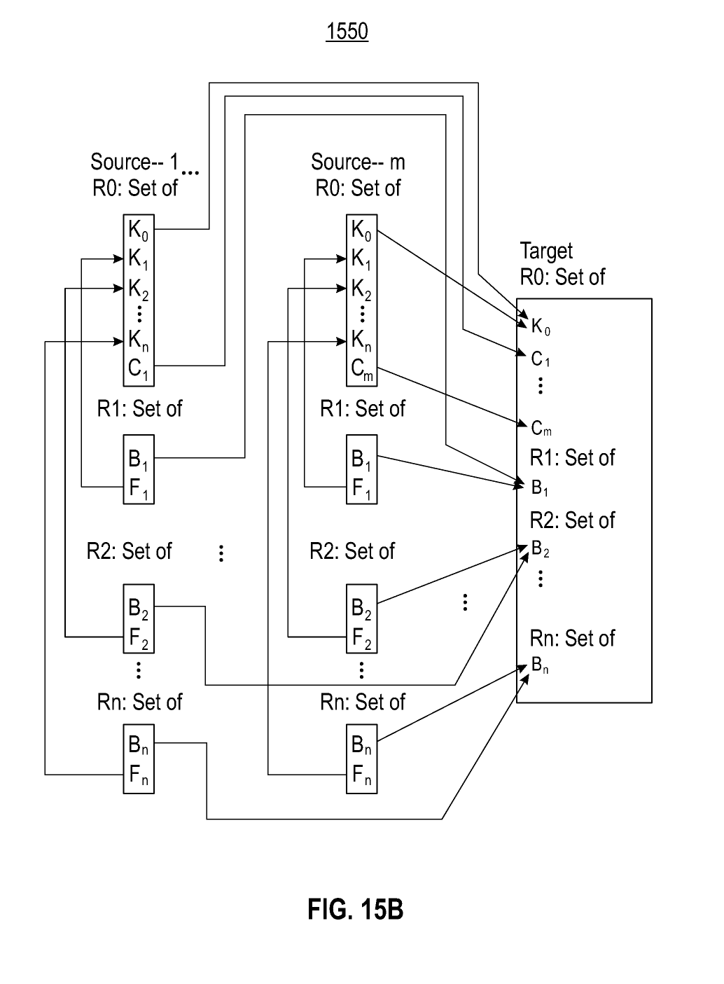

This section reviews the performance and scalability of the nested mapping generation algorithm. FIGS. 15A and 15B depict two synthetic scenarios, chain and authority, respectively. The chain scenario simulates mappings between multiple inter-linked relational tables and an XML target with a large number of nesting levels. The authority scenario simulates mappings between multiple relational tables referencing a central table and a shallow XML target with a large branching factor (i.e., large number of child tables). For each scenario, a schema generator was used to create schema definitions with variable degrees of complexity (e.g., number of elements, referential constraints, number of nesting levels). In addition, each generated source schema was replicated a number of times in order to simulate the cases of multiple data sources mapping into one target.

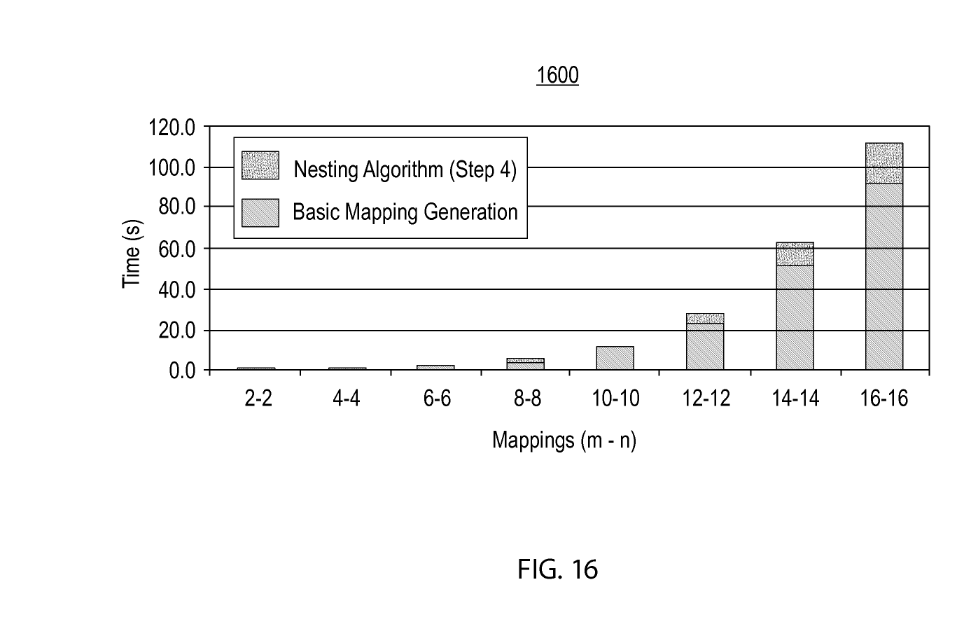

For the chain scenario, the number of different sources (m) and the number of inter-linked relational tables (depth) was increased (i.e., 1≦m≦20 and 1≦depth≦3). In the worst case, the prototype took 0.2 seconds to compute the nested mapping. For the authority scenario, the number of sources (m) and the branching factor (n) (i.e., the number of child tables) were simultaneously increased such that m=n for each trial. FIG. 16 shows the results for the authority scenario. For schemas of small to medium size (e.g., when m and n are less than 12), the nested mapping algorithm finishes in a few seconds after the computation of the basic mappings. But the execution time degrades exponentially as the mapping complexity increases. Note, however, that in the largest case attempted (i.e., m=n=20), the nesting mapping algorithm took only about 20 seconds after the computation of basic mappings.

Finally, the algorithm performance was evaluated with a mapping that uses the Mondial schema, a database of geographical data. Mondial has a relational representation with 28 relations and a maximum branching factor of 9. Its XML Schema counterpart has a maximum depth of 5 and a maximum branching factor of 9. The relational was mapped into the XML representation and 26 basic mappings were created in 1.2 seconds. The nesting algorithm then extracted 10 nested mappings in 2.8 seconds.

### 6. Conclusion

Described herein is a new, structured mapping formalism called nested mappings that provides a natural way to express correlations between schema mappings. The benefits of this formalism are demonstrated herein, including increased specification accuracy and the ability to specify and customize grouping semantics declaratively. An algorithm is provided herein to generate nested mappings from standard schema matchings. The present application shows how to compile these mappings into transformation queries that can be much more efficient than their counterparts obtained from the earlier basic mappings. The new transformation queries also generate much cleaner data. Certainly nested mappings have important applications in schema evolution where the mapping must be able to ensure that the grouping of much of the data is not changed. Indeed the work herein was largely inspired by the inability of existing mapping formalisms to faithfully represent the “identity mapping” for many schemas.

### 7. Computing System

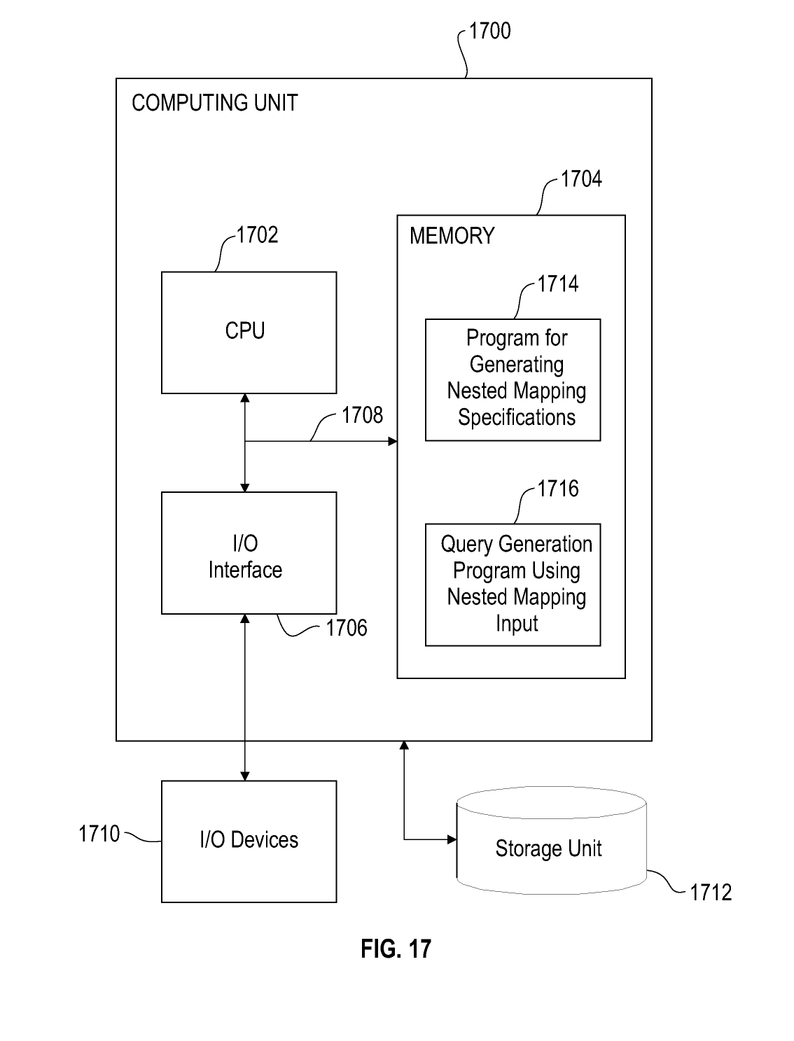

FIG. 17 is a computing system that includes components of the system of FIG. 7A and implements the processes of FIGS. 7B and 10, in accordance with embodiments of the present invention. Computing unit 1700 is suitable for storing and/or executing program code of software programs for generating nested mapping specifications 1714 and for generating transformation queries using nested mapping specifications as input 1716, and generally comprises a central processing unit (CPU) 1702, a memory 1704, an input/output (I/O) interface 1706, a bus 1708, I/O devices 1710 and a storage unit 1712. The program for generating nested mapping specifications 1714 includes, for example, nested mapping generator 708 (see FIG. 7A). The program for generating transformation queries 1716 includes, for instance, query generator 712 (see FIG. 7A). CPU 1702 performs computation and control functions of computing unit 1700. CPU 1702 may comprise a single processing unit, or be distributed across one or more processing units in one or more locations (e.g., on a client and server).

Local memory elements of memory 1704 are employed during actual execution of the program code for generating nested mapping specifications 1714 and for generating transformation queries 1716. Cache memory elements of memory 1704 provide temporary storage of at least some program code in order to reduce the number of times code must be retrieved from bulk storage during execution. Further, memory 1704 may include other systems not shown in FIG. 17, such as an operating system (e.g., Linux) that runs on CPU 1702 and provides control of various components within and/or connected to computing unit 1700.

Memory 1704 may comprise any known type of data storage and/or transmission media, including bulk storage, magnetic media, optical media, random access memory (RAM), read-only memory (ROM), a data cache, a data object, etc. Storage unit 1712 is, for example, a magnetic disk drive or an optical disk drive that stores data. Moreover, similar to CPU 1702, memory 1704 may reside at a single physical location, comprising one or more types of data storage, or be distributed across a plurality of physical systems in various forms. Further, memory 1704 can include data distributed across, for example, a LAN, WAN or storage area network (SAN) (not shown).

I/O interface 1706 comprises any system for exchanging information to or from an external source. I/O devices 1710 comprise any known type of external device, including a display monitor, keyboard, mouse, printer, speakers, handheld device, printer, facsimile, etc. Bus 1708 provides a communication link between each of the components in computing unit 1700, and may comprise any type of transmission link, including electrical, optical, wireless, etc.

I/O interface 1706 also allows computing unit 1700 to store and retrieve information (e.g., program instructions or data) from an auxiliary storage device (e.g., storage unit 1712). The auxiliary storage device may be a non-volatile storage device (e.g., a CD-ROM drive which receives a CD-ROM disk). Computing unit 1700 can store and retrieve information from other auxiliary storage devices (not shown), which can include a direct access storage device (DASD) (e.g., hard disk or floppy diskette), a magneto-optical disk drive, a tape drive, or a wireless communication device.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for generating nested mapping specifications 1714 and for generating transformation queries 1716 for use by or in connection with a computing unit 1700 or any instruction execution system to provide and facilitate the capabilities of the present invention. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, RAM 1704, ROM, a rigid magnetic disk and an optical disk. Current examples of optical disks include compact disk-read-only memory (CD-ROM), compact disk-read/write (CD-R/W) and DVD.

The flow diagrams depicted herein are provided by way of example. There may be variations to these diagrams or the steps (or operations) described herein without departing from the spirit of the invention. For instance, in certain cases, the steps may be performed in differing order, or steps may be added, deleted or modified. All of these variations are considered a part of the present invention as recited in the appended claims.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A computer-implemented method of generating nested mapping specifications, said method comprising:
receiving, by a computing system, one or more source schemas, a target schema, and one or more correspondences between one or more elements of each source schema of said one or more source schemas and one or more elements of said target schema;
generating, by said computing system, a set of basic mappings based on said one or more source schemas, said target schema, and said one or more correspondences;
constructing, by said computing system, a directed acyclic graph (DAG) whose edges represent all possible ways in which each basic mapping of said set of basic mappings is nestable under any other basic mapping of said set of basic mappings;
removing, by said computing system, any transitively implied edges from said DAG;
identifying, by said computing system and subsequent to said modifying, one or more root mappings of said DAG; and
extracting, automatically by said computing system, one or more trees of mappings from said DAG, each tree of mappings being rooted at a root mapping of said one or more root mappings and each tree of mappings expressing a nested mapping specification.

2. The method of claim 1, wherein said constructing comprises: for all pairs (mᵢ, mⱼ) of basic mappings in said set of basic mappings, adding an edge mᵢ→mⱼ to said DAG if mᵢ is nestable inside mⱼ.

3. The method of claim 1, wherein said removing any transitively implied edges from said DAG comprises:
determining that a path mᵢ [symbol] mⱼ is longer than an edge mᵢ→mⱼ of a set of edges included in said DAG; and
removing, in response to said determining, said edge mᵢ→mⱼ from said set of edges, wherein said mᵢ and said mⱼ are basic mappings included in said set of basic mappings.

4. The method of claim 3, further comprising repeating said determining that said path mᵢ [symbol] mⱼ is longer than said edge mᵢ→mⱼ and said removing said edge mᵢ→mⱼ until said set of edges is equal to:
{(mᵢ→mⱼ)|mᵢ [symbol] mⱼ [symbol] ( [symbol] mₖ)(mᵢ [symbol] mₖ [symbol] mₖ [symbol] mⱼ)}.

5. The method of claim 1, wherein said identifying said one or more root mappings of said DAG comprises identifying R, said R being a set of all root mappings in said DAG, wherein said R is equal to:
{mᵣ|mᵣ∃M [symbol] ( [symbol] m′)(mζ∃M [symbol] (mᵣ→m′)∃E)},
wherein said mᵣ is a root mapping of said one or more root mappings, said m′ is a basic mapping of said set of basic mappings, said M is said set of basic mappings, and said E is a set of edges included in said DAG.

6. The method of claim 1, wherein said extracting comprises traversing said DAG depth-first for mᵣ, said mᵣ being a root mapping of a set of all root mappings included in said DAG, said traversing including:
following a reverse direction of a set of edges of said DAG; and
visiting one or more basic mappings of said set of basic mappings, said one or more basic mappings being part of a tree of mappings of said one or more trees of mappings, said tree of mappings rooted at said mᵣ.

7. A computing system comprising a processor coupled to a computer-readable memory unit, said memory unit comprising a software application, said software application comprising instructions that when executed by said processor implement the method of claim 1.

8. A computer program product, comprising a computer usable medium having a computer readable program code embodied therein, said computer readable program code containing instructions that when executed by a processor of a computer system implement a method for generating nested mapping specifications, said method comprising:
computer-usable code for receiving, by a computing system, one or more source schemas, a target schema, and one or more correspondences between one or more elements of each source schema of said one or more source schemas and one or more elements of said target schema;
computer-usable code for generating, by said computing system, a set of basic mappings based on said one or more source schemas, said target schema, and said one or more correspondences;
computer-usable code for constructing, by said computing system, a directed acyclic graph (DAG) whose edges represent all possible ways in which each basic mapping of said set of basic mappings is nestable under any other basic mapping of said set of basic mappings;
computer-usable code for removing, by said computing system, any transitively implied edges from said DAG;
computer-usable code for identifying, by said computing system and subsequent to said modifying, one or more root mappings of said DAG; and
computer-usable code for extracting, automatically by said computing system, one or more trees of mappings from said DAG, each tree of mappings being rooted at a root mapping of said one or more root mappings and each tree of mappings expressing a nested mapping specification.

9. The program product of claim 8, wherein said computer-usable code for constructing comprises: for all pairs (mᵢ, mⱼ) of basic mappings in said set of basic mappings, computer-usable code for adding an edge mᵢ→mⱼ to said DAG if mᵢ is nestable inside mⱼ.

10. The program product of claim 8, wherein said computer-usable code for removing any transitively implied edges from said DAG comprises:
computer-usable code for determining that a path mᵢ [symbol] mⱼ is longer than an edge mᵢ→mⱼ of a set of edges included in said DAG; and
computer-usable code for removing, in response to said determining, said edge mᵢ→mⱼ from said set of edges, wherein said mᵢ and said mⱼ are basic mappings included in said set of basic mappings.

11. The program product of claim 10, further comprising computer-usable code for repeating said determining that said path mᵢ [symbol] mⱼ is longer than said edge mᵢ→mⱼ and said removing said edge mᵢ→mⱼ until said set of edges is equal to:
{(mᵢ→mⱼ)|mᵢ [symbol] mⱼ [symbol] ( [symbol] mₖ)(mᵢ [symbol] mₖ [symbol] mₖ [symbol] mⱼ)}

12. The program product of claim 8, wherein said computer-usable code for identifying said one or more root mappings of said DAG comprises computer-usable code for identifying R, said R being a set of all root mappings in said DAG, wherein said R is equal to:
{mᵣ|mᵣ∃M [symbol] ( [symbol] m′)(m′∃M [symbol] (mᵣ→m′)∃E)},
wherein said mᵣ is a root mapping of said one or more root mappings, said m′ is a basic mapping of said set of basic mappings, said M is said set of basic mappings, and said E is a set of edges included in said DAG.

13. The program product of claim 8, wherein said computer-usable code for extracting comprises computer-usable code for traversing said DAG depth-first for mᵣ, said mᵣ being a root mapping of a set of all root mappings included in said DAG, said computer-usable code for traversing including:
computer-usable code for following a reverse direction of a set of edges of said DAG; and
computer-usable code for visiting one or more basic mappings of said set of basic mappings, said one or more basic mappings being part of a tree of mappings of said one or more trees of mappings, said tree of mappings rooted at said mᵣ.

14. A computer-implemented method of generating a transformation query from a nested mapping specification based on a source schema and a target schema, said method comprising:
generating, by a computing system, a first-phase query for transforming source data into a set of flat views of said target schema; and
generating, by said computing system, a second-phase query as a wrapping query for a nesting of data of said flat views according to a format of said target schema,
wherein said generating said first-phase query includes:
applying default Skolemization to a nested mapping specification, said applying including replacing an existentially-quantified variable in said nested mapping specification by a Skolem function that depends on all universally-quantified variables that are positioned in said nested mapping specification before said existentially-quantified variable;
decoupling, in response to said applying, said nested mapping specification into a set of single-headed constraints, each single-headed constraint including a single implication and an atom included in a consequent of said single implication; and
storing a plurality of facts asserted by said set of single-headed constraints into said set of flat views.

15. The method of claim 14, wherein said applying said default Skolemization comprises:
determining that one or more atomic variables in said nested mapping specification are not keys or foreign keys; and
replacing, in response to said determining, said one or more atomic variables with a null value.

16. The method of claim 14, wherein said applying said default Skolemization comprises replacing one or more existential set variables of said nested mapping specification with Skolem terms.

17. The method of claim 14, wherein a fact of said plurality of facts associates a tuple and a set identifier, said set identifier associated with a set type of one or more set types included in said target schema, said tuple asserted by a mapping associated with said set type, wherein said set type is directly nested under another set type of said target schema, and wherein said set type is not at a top level of said target schema.

18. The method of claim 14, further comprising optimizing said second-phase query, said optimizing including:
inlining said set of flat views into a plurality of places where said flat views occur in said second-phase query;
replacing one or more equalities of function terms of said second-phase query with one or more equalities of arguments of said second-phase query to obtain a rewritten query;
determining that one or more inner loops of said rewritten query are redundant; and
removing said one or more inner loops from said rewritten query to obtain an optimized query.

19. A computing system comprising a processor coupled to a computer-readable memory unit, said memory unit comprising a software application, said software application comprising instructions that when executed by said processor implement the method of claim 14.

20. A computer program product, comprising a computer-usable medium having a computer-readable program code embodied therein, said computer-readable program code comprising an algorithm adapted to implement the method of claim 14.
